(19) United States
(12) Patent Application Publication
(10) Pub. No.: US 2017/0017174 A1
(43) Pub. Date: Jan. 19, 2017

(54) RESIN COMPOSITION, ELECTROSTATIC CHARGE IMAGE DEVELOPING TONER, AND TONER CARTRIDGE

(71) Applicant: FUJI XEROX CO., LTD., Tokyo (JP)

(72) Inventors: Hiroshi SAEGUSA, Kanagawa (JP); Takahiro ISHIZUKA, Kanagawa (JP)

(73) Assignee: FUJI XEROX CO., LTD., Tokyo (JP)

(21) Appl. No.: 15/001,783

(22) Filed: Jan. 20, 2016

(30) Foreign Application Priority Data
Jul. 16, 2015 (JP) 2015-142371
Jul. 16, 2015 (JP) 2015-142372

(51) Int. Cl. G03G 9/00

(52) U.S. Cl. CPC G03G 9/08755; C08K 5/45

(57) ABSTRACT

A resin composition includes a polyester resin which contains a structural unit derived from bisphenol A in an amount of 1% by weight or less with respect to the total amount of polyester resin; and a compound represented by the following Formula (I):

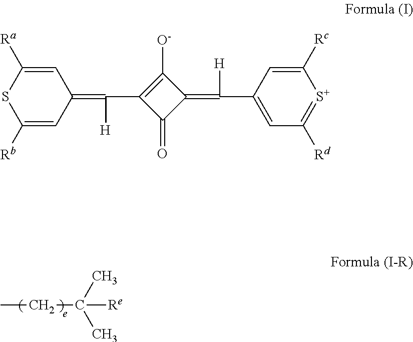

wherein, in Formula (I), R^{a} represents a group represented by Formula (I-R), and each of R^{b}, R^{c}, and R^{d} independently represents an alkyl group; and in Formula (I-R), R^{e} represents hydrogen or a methyl group, and e represent an integer from 0 to 3.

### CROSS-REFERENCE TO RELATED APPLICATIONS

This application is based on and claims priority under 35 USC 119 from Japanese Patent Application No. 2015-142371 filed Jul. 16, 2015 and Japanese Patent Application No. 2015-142372 filed Jul. 16, 2015.

### BACKGROUND

### Technical Field

The present invention relates to a resin composition, an electrostatic charge image developing toner, and a toner cartridge.

### SUMMARY

According to an aspect of the invention, there is provided a resin composition, including:

a polyester resin which contains a structural unit derived from bisphenol A in an amount of 1% by weight or less with respect to the total amount of polyester resin; and

a compound represented by the following Formula (I):

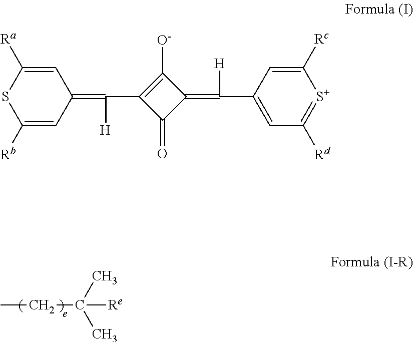

wherein, in Formula (I), R^{a} represents a group represented by Formula (I-R), and each of R^{b}, R^{c}, and R^{d} independently represents an alkyl group; and

in Formula (I-R), R^{e} represents hydrogen or a methyl group, and e represent an integer from 0 to 3.

### BRIEF DESCRIPTION OF THE DRAWINGS

Exemplary embodiments of the present invention will be described in detail based on the following figures, wherein:

FIG. 1 is a configuration diagram schematically showing one example of an image forming apparatus according to an exemplary embodiment.

### DETAILED DESCRIPTION

Hereinafter, an exemplary embodiment showing an example of the present invention will be described.

Resin Composition

A resin composition according to a first aspect in the exemplary embodiment includes a polyester resin containing a structural unit derived from bisphenol A in an amount of 1% by weight or less with respect to the total amount of polyester resin (hereinafter, referred to as “specific polyester resin” in some cases) and a compound represented by the following Formula (I) (hereinafter, referred to as “specific infrared absorbent” in some cases).

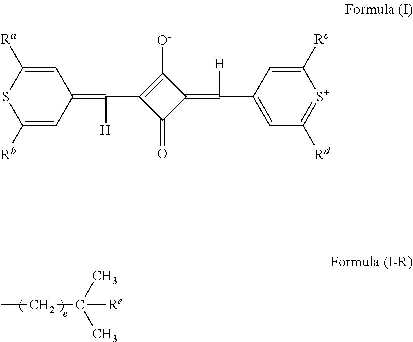

In Formula (I), R^{a} represents a group represented by Formula (I-R), and each of R^{b}, R^{c}, and R^{d} independently represents an alkyl group.

In Formula (I-R), R^{e} represents hydrogen or a methyl group, and e represent an integer from 0 to 3.

In the resin composition according to the first aspect, by having the above-described configuration, deterioration of infrared absorption performance is prevented, compared to a resin composition using the specific polyester resin and the following infrared absorbent (A4) (hereinafter, referred to as “comparative infrared absorbent” in some cases) instead of the specific infrared absorbent.

In the related art, using a polyester resin (hereinafter, referred to as “polyester resin in the related art” in some cases) in which the structural unit derived from bisphenol A is greater than 1% by weight with respect to the total amount of polyester resin, as a resin, and an infrared absorbent, a resin composition having a great infrared absorption amount is obtained. However, when the specific polyester resin is used, even using an infrared absorbent having the same concentration, the infrared absorption amount of the resin composition becomes small compared to a case where the polyester resin in the related art is used. That is, by mixing an infrared absorbent with the specific polyester resin, the infrared absorption performance of the infrared absorbent is deteriorated in some cases.

As one of the causes in which the infrared absorption performance of the infrared absorbent is deteriorated by mixing with the specific polyester resin, the low solubility of the infrared absorbent with respect to the specific polyester resin is exemplified. Specifically, it is thought that, in a case where the polyester resin in the related art is used, the solubility of an infrared absorbent with respect to the resin is increased by the bisphenol A skeleton in the polyester resin in the related art, but, since the structural unit derived from bisphenol A in the specific polyester resin is 1% by weight or less, the solubility of an infrared absorbent is low. It is considered that an infrared absorbent is less likely to be dispersed in the specific polyester resin due to the low solubility, and the infrared absorption performance is less likely to be exhibited due to uneven distribution of the infrared absorbent.

On the other hand, when the specific infrared absorbent is used as an infrared absorbent, even in a case where the resin is the specific polyester resin, a resin composition in which deterioration of infrared absorption performance is prevented is obtained. The reason for this is not clear, but, it is considered that this is because, since the specific infrared absorbent has a branched alkyl group at a terminal of the molecule, the solubility becomes high even with respect to the specific polyester resin having a small number of bisphenol A skeleton, and the infrared absorption amount of the obtained resin composition becomes great.

As described above, the specific infrared absorbent imparts high infrared absorption performance to a wide range of resins including the specific polyester resin.

In addition, the resin composition according to the second aspect in the exemplary embodiment includes an acrylic resin (hereinafter, referred to as “specific acrylic resin” in some cases) having an OH group on a branch (specific infrared absorbent) and a compound represented by the following Formula (I).

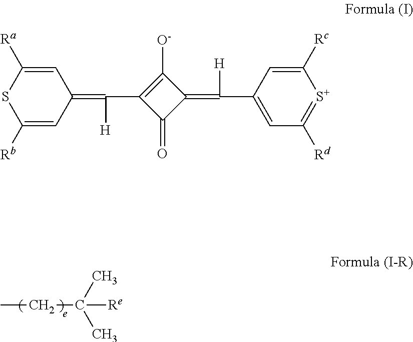

In Formula (I), R^{a} represents a group represented by Formula (I-R), and each of R^{b}, R^{c}, and R^{d} independently represents an alkyl group.

In Formula (I-R), R^{e} represents hydrogen or a methyl group, and e represent an integer from 0 to 3.

In the resin composition according to the second aspect, by having the above-described configuration, deterioration of infrared absorption performance is prevented, compared to a resin composition using the specific polyester resin and a comparative infrared absorbent instead of the specific infrared absorbent.

In a case where an acrylic resin (hereinafter, referred to as “acrylic resin in the related art” in some cases) not having an OH group on a branch thereof is used as a resin, even using a comparative infrared absorbent, a resin composition having a great infrared absorption amount is obtained. However, when the specific acrylic resin is used, even using a comparative infrared absorbent having the same concentration, the infrared absorption performance of the resin composition is deteriorated compared to a case where an acrylic resin in the related art is used. The reason for this is not clear, however, it is considered that this is because, since the specific acrylic resin has an OH group on a branch thereof, the polarity is high, and the solubility with respect to the specific acrylic resin of a comparative infrared absorbent is low.

On the other hand, when the infrared absorbent is used, even using the specific acrylic resin, a resin composition in which deterioration of infrared absorption performance is prevented compared to a case where a comparative infrared absorbent is used is obtained. The reason for this is not clear, however, it is considered that this is because, since the specific infrared absorbent has a branched alkyl group at a terminal of the molecule, the solubility becomes high even with respect to the specific acrylic resin having a high polarity, and the infrared absorption amount of the obtained resin composition becomes great.

As described above, the specific infrared absorbent imparts high infrared absorption performance to a wide range of resins including the specific acrylic resin.

Resin

Specific Polyester Resin

The resin composition according to the first aspect includes at least the specific polyester resin as a resin, and may contain a resin other than the polyester resin, as necessary. Here, the ratio of the specific polyester resin to the total amount of resin included in the resin composition according to the first aspect is preferably 10% by weight or greater, more preferably 40% by weight or greater, and most preferably 100% by weight. The specific polyester resin may be included in the resin composition as a binder resin.

The specific polyester resin is not particularly limited as long as the structural unit derived from bisphenol A therein is 1% by weight or less with respect to the total amount of polyester resin. The specific polyester preferably substantially does not include the structural unit derived from bisphenol A, and more preferably does not include the structural unit derived from bisphenol A at all.

As a method of determining the content of the structural unit derived from bisphenol A, a method of determining the content by analyzing the compositional ratio of the polyester resin included in a resin composition using NMR or the like is exemplified.

Moreover, the “structural unit derived from bisphenol A” in the present specification means a structure represented by the following Formula (R) (hereinafter, referred to as “bisphenol A structure” in some cases). That is, the “structural unit derived from bisphenol A” is a concept that also includes the bisphenol A structure in a polyester resin obtained by using a modified bisphenol A as a monomer, in addition to the bisphenol A structure in a polyester resin obtained by using a substance other than bisphenol A as a monomer.

Here, the “modified bisphenol A” in the present specification means a compound in which a hydrogen atom of a hydroxy group in bisphenol A is substituted, and specific examples thereof include bisphenol A alkyleneoxide adducts.

In addition, “the content of the structural unit derived from bisphenol A” in a polyester resin obtained by using a modified bisphenol A as a monomer means the content calculated from the weight of only the bisphenol A structure represented by the following Formula (R), not including the weight of the modified portion. Specifically, for example, in a case where a bisphenol A alkyleneoxide adduct is used as a modified bisphenol A, “the content of the structural unit derived from bisphenol A” means the weight of the bisphenol A structure with respect to the total weight of the polyester resin, which is the weight obtained by calculation without including the weight of the alkyleneoxide.

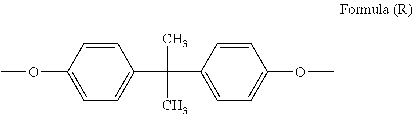

In addition, the specific polyester more preferably substantially also does not include the structural unit derived from a bisphenol A derivative, in addition to the structural unit derived from bisphenol A. That is, the total amount of the content of the structural unit derived from bisphenol A and the content of a bisphenol A skeleton included in the structural unit derived from a bisphenol A derivative is more preferably 1% by weight or less with respect to the total amount of polyester resin, and it is particularly preferable that the structural unit derived from bisphenol A and the structural unit derived from a bisphenol A derivative are not included at all.

Here, as the bisphenol A derivative, a derivative in which hydrogen bonding to a benzene ring of bisphenol A is substituted with a substituent is exemplified.

In addition, “the content of a bisphenol A skeleton included in the structural unit derived from a bisphenol A derivative” means the content obtained by replacing the structural unit derived from a bisphenol A derivative of a bisphenol A structure and by being calculated from the weight of the replaced bisphenol A structure, not including the weight of a substituent.

Examples of the specific polyester resin include polycondensates of polycarboxylic acids and polyols other than bisphenol A. Moreover, a commercially available product may be used, or a synthesized product may be used, as the specific polyester resin.

Examples of the polycarboxylic acid include aliphatic dicarboxylic acids (for example, oxalic acid, malonic acid, maleic acid, fumaric acid, citraconic acid, itaconic acid, glutaconic acid, succinic acid, alkenyl succinic acid, adipic acid, and sebacic acid), alicyclic dicarboxylic acids (for example, cyclohexanedicarboxylic acid), aromatic dicarboxylic acids (for example, terephthalic acid, isophthalic acid, phthalic acid, and naphthalenedicarboxylic acid), anhydrides thereof, or lower alkyl esters (for example, having 1 to 5 carbon atoms) thereof. Among these, as the polycarboxylic acid, for example, aromatic dicarboxylic acids are preferable.

As the polycarboxylic acid, a tri- or higher carboxylic acid having a crosslinked structure or a branched structure may be used in combination together with a dicarboxylic acid. Examples of the tri- or higher carboxylic acid include trimellitic acid, pyromellitic acid, anhydrides thereof, or lower alkyl esters (for example, having 1 to 5 carbon atoms) thereof.

The polycarboxylic acids may be used alone or in combination of two or more types thereof.

Examples of the polyol include aliphatic diols (for example, ethylene glycol, diethylene glycol, triethylene glycol, propylene glycol, butanediol, hexanediol, and neopentyl glycol), alicyclic diols (for example, cyclohexanediol, cyclohexanedimethanol, and hydrogenated bisphenol A), and aromatic diols other than bisphenol A (for example, hydroquinone and 4,4′-dihydroxybiphenyl). Among these, as the polyol, aliphatic diols or alicyclic diols are preferable, and aliphatic diols are more preferable.

As the polyol, a tri- or higher alcohol having a crosslinked structure or a branched structure may be used in combination together with a diol. Examples of the tri- or higher alcohol include glycerin, trimethylolpropane, and pentaerythritol.

The polyols may be used alone or in combination of two or more types thereof.

Although the glass transition temperature (Tg) of the specific polyester resin is not particularly limited, for example, in a case where the resin composition is used in the electrostatic charge image developing toner, the glass transition temperature is preferably from 50° C. to 80° C., and more preferably from 50° C. to 65° C.

As a method of adjusting the glass transition temperature of the specific polyester resin (Tg) to the above range, a method in which at least one type of an aromatic dicarboxylic acid and an aromatic diol other than bisphenol A is used at a greater amount compared to a case where a polyester resin in the related art is synthesized is exemplified.

The glass transition temperature is determined by a DSC curve obtained by differential scanning calorimetry (DSC). More specifically, the glass transition temperature is determined by “extrapolation glass transition starting temperature” disclosed in a method of determining the glass transition temperature of JIS K 7121-1987 “Testing Methods for Transition Temperature of Plastics”.

Although the weight average molecular weight (Mw) of the specific polyester resin is not particularly limited, for example, in a case where the resin composition is used in the electrostatic charge image developing toner, the weight average molecular weight is preferably from 5,000 to 1,000, 000, and more preferably from 7,000 to 500,000.

Although the number average molecular weight (Mn) of the specific polyester resin is not particularly limited, for example, in a case where the resin composition is used in the electrostatic charge image developing toner, the number average molecular weight is preferably from 2,000 to 100,000.

Although the molecular weight distribution Mw/Mn of the specific polyester resin is not particularly limited, for example, in a case where the resin composition is used in the electrostatic charge image developing toner, the molecular weight distribution is preferably from 1.5 to 100, and more preferably from 2 to 60.

Moreover, the weight average molecular weight and the number average molecular weight are measured by gel permeation chromatography (GPC). In the molecular weight measurement by GPC, HLC-8120, GPC manufactured by Tosoh Corporation is used as a measurement apparatus, TSKgel Super HM-M (15 cm) manufactured by Tosoh Corporation is used as a column, and a THF solvent is used. The weight average molecular weight and the number average molecular weight are calculated using a molecular weight calibration curve created by monodisperse polystyrene standard samples from the measurement results.

The specific polyester resin is obtained by a known preparation method. Specific examples thereof include a method of conducting a reaction at a polymerization temperature set to from 180° C. to 230° C., if necessary, under reduced pressure in the reaction system, while removing water or alcohol generated during condensation.

When monomers of the raw materials are not dissolved or compatibilized at a reaction temperature, a high boiling point solvent may be added as a solubilizing agent to dissolve the monomers. In this case, a polycondensation reaction is performed while distilling off the solubilizing agent. When a monomer having poor compatibility is present in a copolymerization reaction, the monomer having poor compatibility and an acid or an alcohol to be polycondensed with the monomer may be condensed in advance and then polycondensed with the major component.

Specific Acrylic Resin

The resin composition according to the second aspect includes at least a specific acrylic resin as a resin, and may contain a resin other than the acrylic resin, as necessary. Here, the ratio of the specific acrylic resin to the total amount of resin included in the resin composition according to the second aspect is preferably 20% by weight or greater, more preferably 40% by weight or greater, and most preferably 100% by weight. The specific acrylic resin may be included in the resin composition as a binder resin.

The “acrylic resin” in the present specification refers to a resin including a structural unit derived from a monomer having at least one type (hereinafter, referred to as “(meth)acryloyloxy group” in some cases) of an acryloyloxy group and a methacryloyloxy group.

Moreover, a monomer having an acryloyloxy group is referred to as “acrylic monomer”, a monomer having a methacryloyloxy group is referred to as “methacrylic monomer”, and a monomer having a (meth)acryloyloxy group is referred to as “(meth)acrylic monomer”, in some cases.

The acrylic resin may include at least a structural unit derived from a (meth)acrylic monomer, or may include a structural unit derived from a monomer other than the (meth)acrylic monomer (hereinafter, referred to as “other monomers” in some cases). That is, in the present specification, a copolymer of a (meth)acrylic monomer and one of other monomers also corresponds to the “acrylic resin”.

The specific acrylic resin is not particularly limited as long as it is an acrylic resin having an OH group on a branch thereof. The specific acrylic resin may be a resin including a structural unit derived from a (meth)acrylic monomer having an OH group, or may be a resin including a structural unit derived from a (meth)acrylic monomer and a structural unit derived from other monomers having an OH group. Among these, the specific acrylic resin preferably includes a structural unit derived from a (meth)acrylic monomer having an OH group.

Here, the “OH group” in the present specification means a group represented by “—OH”, and is a concept that also includes “—OH” in, for example, a carboxy group, in addition to a hydroxy group. In addition, the “branch” refers to a carbon chain having 2 or more carbon atoms which bonds to the main chain (chain which is a longest stem, in a molecular structure of a resin).

Examples of the specific acrylic resin include a copolymer of a (meth)acrylic monomer having an OH group and a (meth)acrylic monomer not having an OH group, a copolymer of a (meth)acrylic monomer having an OH group, a (meth)acrylic monomer not having an OH group, and one of other monomers not having an OH group, a copolymer of a (meth)acrylic monomer having an OH group, a (meth)acrylic monomer not having an OH group, one of other monomers having an OH group, and one of other monomers not having an OH group, a copolymer of a (meth)acrylic monomer not having an OH group, one of other monomers having an OH group, and one of other monomers not having an OH group, and a copolymer of a (meth)acrylic monomer not having an OH group, and one of other monomers having an OH group.

Moreover, a commercially available product may be used, or a synthesized product may be used, as the specific acrylic resin.

As the acrylic monomer having an OH group, acrylates having an OH group are exemplified, and specific examples thereof include monofunctional hydroxyalkyl acrylates such as 2-hydroxyethyl acrylate, 2-hydroxypropyl acrylate, 4-hydroxybutyl acrylate, and 1,4-cyclohexanedimethanol monoacrylate; and monofunctional carboxyalkyl acrylates such as 2-carboxyethyl acrylate. In addition, 2-acryloyloxyethyl-2-hydroxyethyl-phthalate is exemplified as an acrylate having an OH group in addition to the monofunctional hydroxyalkyl acrylates and the monofunctional carboxyalkyl acrylates.

Among these, as the acrylic monomer having an OH group, a hydroxyalkyl acrylate is preferable, and a hydroxyalkyl acrylate in which the alkyl chain has 2 to 4 carbon atoms is more preferable.

Specific examples and preferable examples of the acrylic monomer having an OH group include a methacrylic monomer corresponding to the above-described acrylic monomer having an OH group (that is, a compound in which an acryloyl group of an acrylic monomer having an OH group is substituted with a methacryloyl group).

The (meth)acrylic monomer having an OH group may be used alone or in combination of two or more types thereof.

Examples of the acrylic monomer not having an OH group include acrylic acid and acrylates not having an OH group.

Examples of the acrylates not having an OH group include monofunctional acrylates having a linear alkyl group such as n-methyl acrylate, n-ethyl acrylate, n-propyl acrylate, n-butyl acrylate, n-pentyl acrylate, n-hexyl acrylate, n-heptyl acrylate, n-octyl acrylate, n-decyl acrylate, n-dodecyl acrylate, n-lauryl acrylate, n-tetradecyl acrylate, n-hexadecyl acrylate, and n-octadecyl acrylate; monofunctional acrylates having a branched alkyl group such as isopropyl acrylate, isobutyl acrylate, t-butyl acrylate, isopentyl acrylate, neopentyl acrylate, isohexyl acrylate, isoheptyl acrylate, isooctyl acrylate, and 2-ethylhexyl acrylate; monofunctional acrylate having an aromatic ring such as phenyl acrylate, biphenyl acrylate, diphenylethyl acrylate, t-butylphenyl acrylate, and terphenyl acrylate; monofunctional acrylates having a cycloalkyl group such as cyclohexyl acrylate and t-butylcyclohexyl acrylate; monofunctional acrylates having an amino group such as dimethylaminoethyl acrylate and diethylaminoethyl acrylate; monofunctional acrylates having an alkoxy group such as methoxyethyl acrylate; and multifunctional acrylate such as ethyleneglycol diacrylate, nonanediol diacrylate, decanediol diacrylate, and trimethylolpropane triacrylate.

Among these, as the acrylic monomer not having an OH group, acrylic acid or a monofuctional acrylate is preferable, and acrylic acid or a monofuctional acrylate having an alkyl group is more preferable.

Specific examples and preferable examples of the acrylic monomer not having an OH group include a methacrylic monomer corresponding to the above-described acrylic monomer not having an OH group (that is, a compound in which an acryloyl group of an acrylic monomer not having an OH group is substituted with a methacryloyl group).

The (meth)acrylic monomer not having an OH group may be used alone or in combination of two or more types thereof.

As other monomers, a monomer having a vinyl group is exemplified, and specific examples thereof include styrenes, vinyl nitriles, vinyl ethers, vinyl ketones, acids having a vinyl group, bases having a vinyl group, and esters having a vinyl group.

Examples of the styrenes include styrene, alkyl-substituted styrenes (for example, α-methyl styrene, 2-methyl styrene, 3-methyl styrene, 4-methyl styrene, 2-ethyl styrene, 3-ethyl styrene, and 4-ethyl styrene), halogen-substituted styrenes (for example, 2-chlorostyrene, 3-chlorostyrene, and 4-chlorostyrene), vinyl naphthalenes (2-vinyl naphthalene, and the like), and hydroxystyrenes (4-ethenyl phenol, and the like).

Examples of the vinyl nitriles include acrylonitrile and methacrylonitrile.

Examples of the vinyl ethers include vinyl methyl ether, vinyl isobutyl ether, and hydroxyalkyl vinyl ethers (2-hydroxyethyl vinyl ether and the like).

Examples of the vinyl ketone include vinyl methyl ketone, vinyl ethyl ketone, and vinyl alkyl ketones such as vinyl isopropenyl ketone and the like.

Examples of the acids having a vinyl group include maleic acid, cinnamic acid, fumaric acid, and vinyl sulfonic acid.

Examples of the bases having a vinyl group include vinyl pyridine and vinyl amine.

Examples of the esters having a vinyl group include vinyl acetate.

Among these, as other monomers, styrenes are preferable, styrene, alkyl-substituted styrenes, or hydroxy styrenes are more preferable, and styrene or alkyl-substituted styrenes are still more preferable.

Other monomers may be used alone or in combination of two or more types thereof.

The content of the OH group in the specific acrylic resin is, for example, from 10 mgKOH/g to 200 mgKOH/g, preferably from 20 mgKOH/g to 150 mgKOH/g, and more preferably from 30 mgKOH/g to 120 mgKOH/g.

Although the glass transition temperature (Tg) of the specific acrylic resin is not particularly limited, for example, in a case where the resin composition is used in the electrostatic charge image developing toner, the glass transition temperature is preferably from 50° C. to 80° C., and more preferably from 50° C. to 65° C.

The glass transition temperature is determined by a DSC curve obtained by differential scanning calorimetry (DSC). More specifically, the glass transition temperature is determined by “extrapolation glass transition starting temperature” disclosed in a method of determining the glass transition temperature of JIS K 7121-1987 “Testing Methods for Transition Temperature of Plastics”.

Although the weight average molecular weight (Mw) of the specific acrylic resin is not particularly limited, for example, in a case where the resin composition is used in the electrostatic charge image developing toner, the weight average molecular weight is preferably from 5,000 to 1,000,000, and more preferably from 7,000 to 500,000.

Although the number average molecular weight (Mn) of the specific acrylic resin is not particularly limited, for example, in a case where the resin composition is used in the electrostatic charge image developing toner, the number average molecular weight is preferably from 2,000 to 100,000.

Although the molecular weight distribution Mw/Mn of the specific acrylic resin is not particularly limited, for example, in a case where the resin composition is used in the electrostatic charge image developing toner, the molecular weight distribution is preferably from 1.5 to 100, and more preferably from 2 to 60.

Moreover, the weight average molecular weight and the number average molecular weight are measured by gel permeation chromatography (GPC). In the molecular weight measurement by GPC, HLC-8120, GPC manufactured by Tosoh Corporation is used as a measurement apparatus, TSKgel Super HM-M (15 cm) manufactured by Tosoh Corporation is used as a column, and a THF solvent is used. The weight average molecular weight and the number average molecular weight are calculated using a molecular weight calibration curve created by monodisperse polystyrene standard samples from the measurement results.

The specific acrylic resin is obtained by a known preparation method. Specifically, for example, the specific acrylic resin are obtained by polymerizing a (meth)acrylic monomer and, as necessary, other monomer by a radical polymerization method such as an emulsion polymerization method, a soap-free emulsion polymerization method, a suspension polymerization method, a miniemulsion polymerization method, or a microemulsion polymerization method.

Infrared Absorbent

The resin composition according to the exemplary embodiment includes the compound represented by Formula (I) as an infrared absorbent.

In Formula (I), R^{a} represents the group represented by Formula (I-R).

The total number of carbon atoms of the group represented by Formula (I-R) is preferably 6 or less, more preferably 5 or less, still more preferably 4 or less, and particularly preferably 3. Moreover, the lower limit of the total number of carbon atoms is 3.

In Formula (I-R), R^{e} represents a hydrogen atom or a methyl group, and preferably represents a methyl group. In a case where R^{e} in Formula (I-R) is a methyl group, the resultant structure is a structure in which the terminal is branched into three (tertiary), and therefore, deterioration of infrared absorption performance is further prevented compared to a case where R^{e} is a hydrogen atom. It is thought that this is because the structure in a case where R^{e} is a methyl group is bulkier compared to that in a case where R^{e} is a hydrogen atom, and thus, decomposition of the compound represented by Formula (I) is further prevented.

In Formula (I-R), e represents an integer from 0 to 3, is preferably an integer from 0 to 2, more preferably 0 or 1, and still more preferably 0. As the value of e in Formula (I-R) is smaller, deterioration of infrared absorption performance is further prevented. It is thought that this is because, as the value of e is smaller, the distance between the branched structure portion in the group represented by Formula (I-R) and the squarylium structure in the compound represented by Formula (I) becomes closer, the chance for the factor (base or the like) contributing to decomposition to act on the molecules of the compound represented by Formula (I) is prevented, and thus, decomposition is further prevented.

Specific examples of the group represented by Formula (I-R) include an i-propyl group, a t-butyl group, an i-butyl group (2-methylpropan-1-yl group), an i-pentyl group (3-methylbutan-1-yl group), a t-pentyl group (2,2-dimethylpropan-1-yl group), an-hexyl group (4-methylpentan-1-yl group), a t-hexyl group (3,3-dimethylbutan-1-yl group), and a t-heptyl group (4,4-dimethylpentan-1-yl group). Among these, an i-propyl group, a t-butyl group, or an i-butyl group (2-methylpropan-1-yl group) is more preferable, and a t-butyl group is still more preferable.

In Formula (I), each of R^{b}, R^{c}, and R^{d} independently represents an alkyl group. At least one of R^{b}, R^{c}, and R^{d} is preferably the group represented by Formula (I-R), and all of R^{b}, R^{c} and R^{d} are more preferably the groups represented by Formula (I-R). As the number of groups represented by Formula (I-R) in Formula (I) is larger, deterioration of infrared absorption performance is further prevented. It is thought that this is because, as the number of groups represented by Formula (I-R) is larger, the structure becomes bulkier, the chance for the factor (base or the like) contributing to decomposition to act on the molecules of the compound represented by Formula (I) is prevented, and thus, decomposition is further prevented.

In a case where one of R^{b}, R^{c}, and R^{d} is the group represented by Formula (I-R), that is, in a case where the compound represented by Formula (I) has two groups represented by Formula (I-R), R^{a} and R^{b} may be the groups represented by Formula (I-R), and R^{a} and Ire or R^{d} may be the groups represented by Formula (I-R).

In a case where two or more of R^{a} to R^{d} are the groups represented by Formula (I-R), the structures of plural groups represented by Formula (I-R) may be the same as or different from each other, respectively. In addition, the preferable structure in a case where at least one of R^{b}, R^{c}, and R^{d} is the group represented by Formula (I-R) is the same as that described above.

In Formula (I), the alkyl group in a case where at least one of R^{b}, R^{c}, and R^{d} is a group other than the group represented by Formula (I-R) may have any one of a linear structure, a branched structure, and a cyclic structure. The alkyl group in this case preferably has a larger number of branches, and more preferably a shorter carbon chain. The number of carbon atoms is preferably from 1 to 20, more preferably from 1 to 8, and still more preferably from 1 to 6.

Specific examples thereof include a methyl group, an ethyl group, a n-propyl group, a n-butyl group, a n-pentyl group, a n-hexyl group, a s-butyl (2-butyl group), a 2-methylbutan-2-yl group, a 3-methylbutan-2-yl group, a 3,3-dimethylbutan-2-yl group, a 3-pentyl group, a 2-methylpentan-3-yl group, a 3-methylpentan-3-yl group, a cyclopentyl group, and a cyclohexyl group. In a case where at least one of R^{b}, R^{c}, and R^{d} is a group other than the group represented by Formula (I-R), among the above specific examples, a 2-methylbutan-2-yl group or a 3-methylpentan-3-yl group is preferable.

Hereinafter, specific examples (exemplary compounds) of the compound represented by Formula (I) will be shown. Moreover, the compound represented by Formula (I) is not limited thereto.

First, specific examples which have four groups represented by Formula (I-R) are shown.

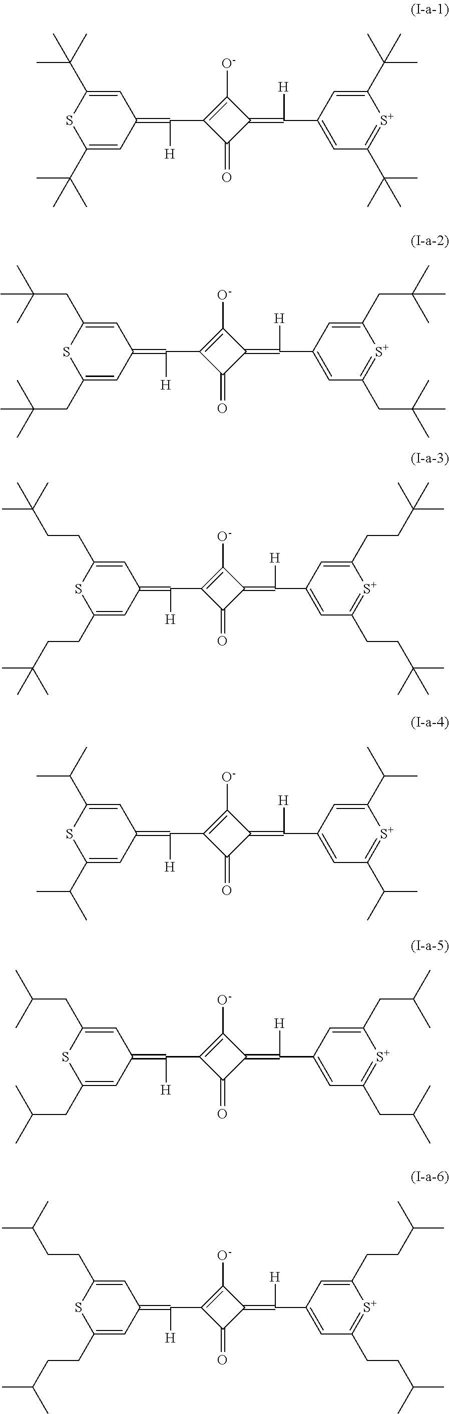

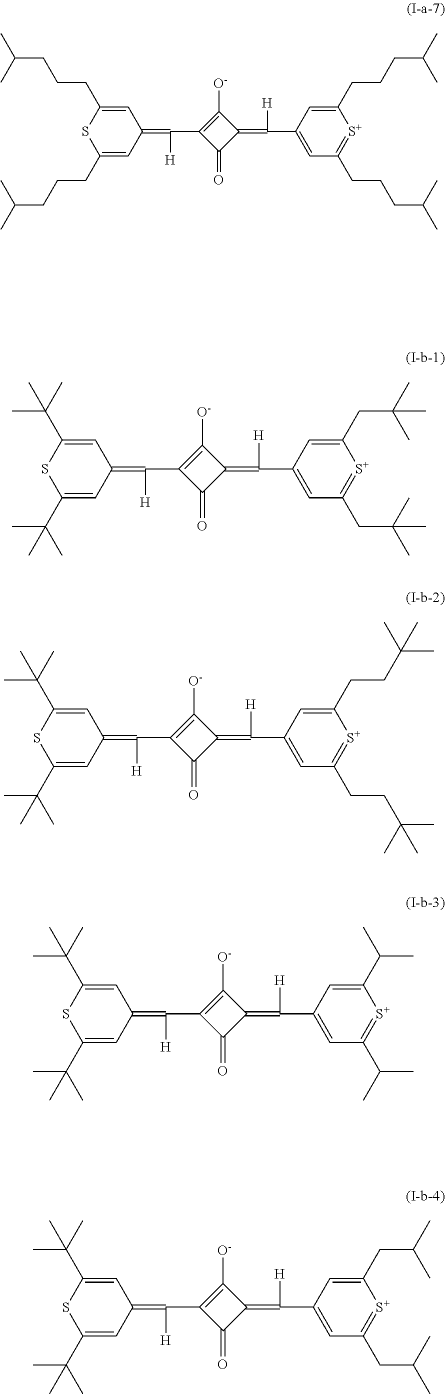

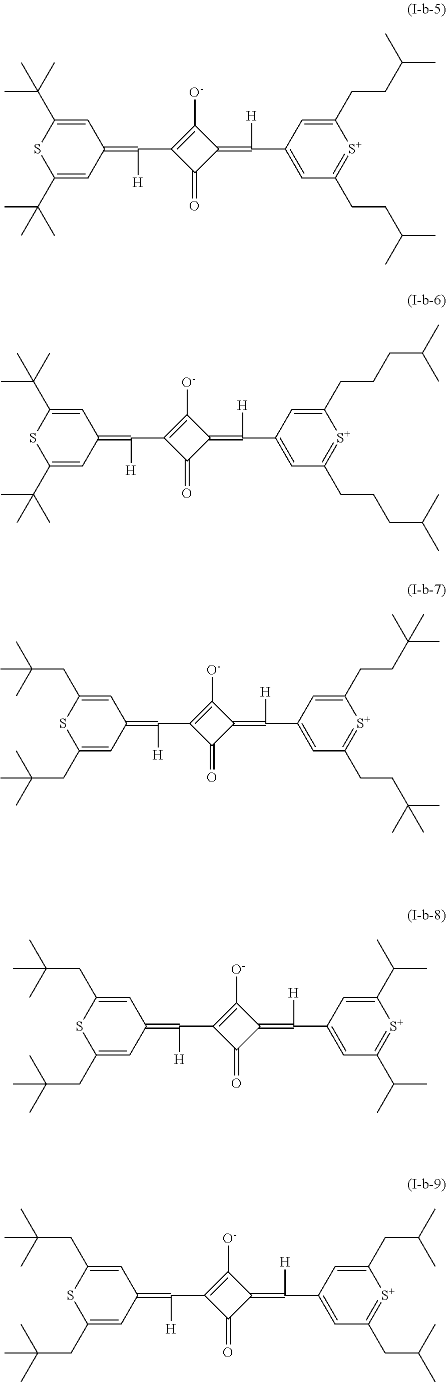

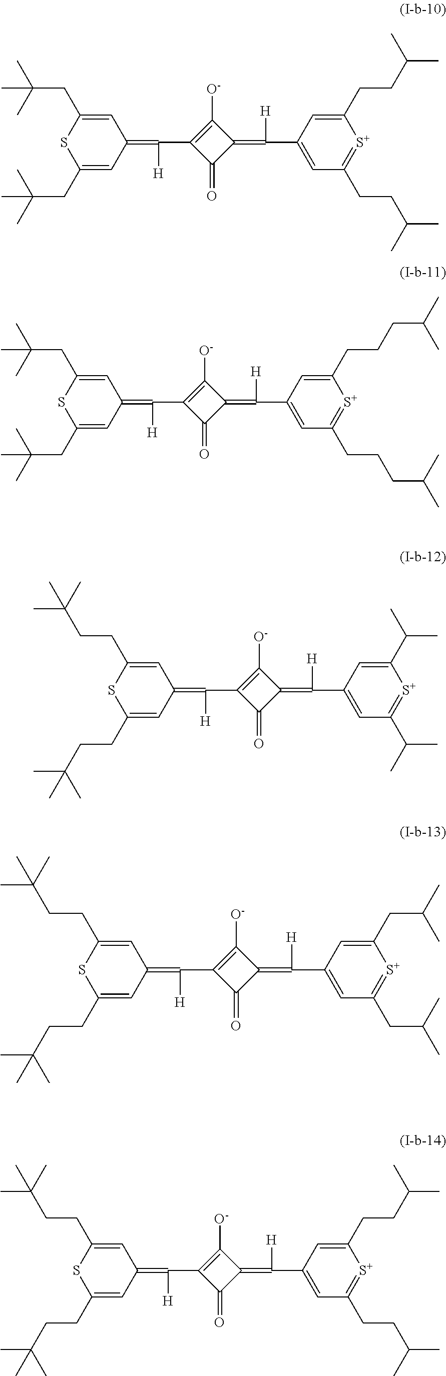

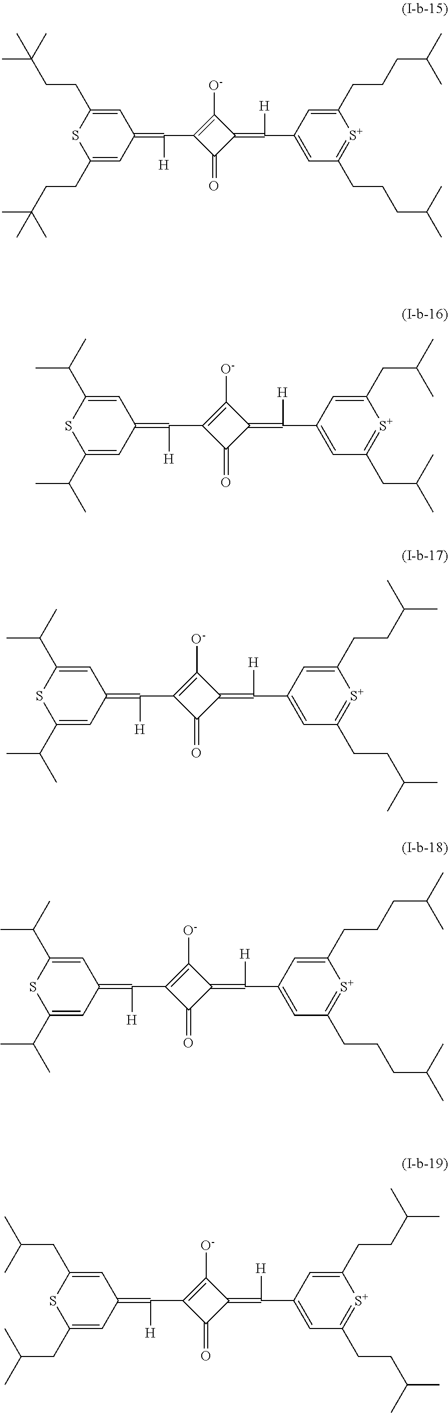

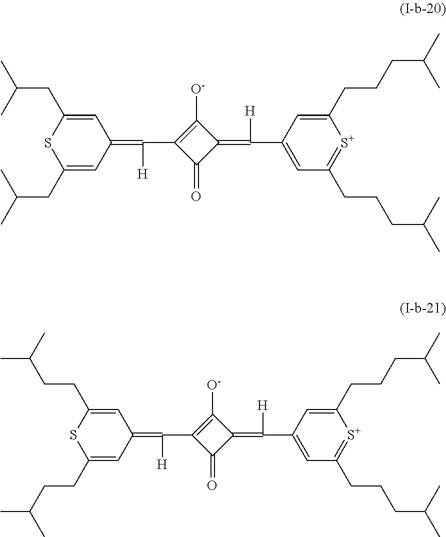

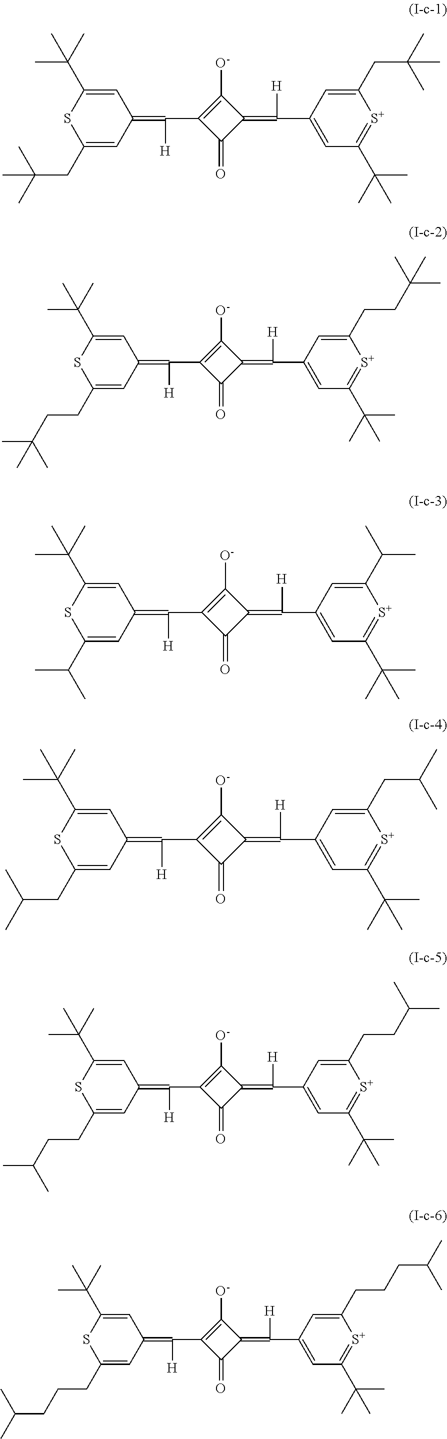

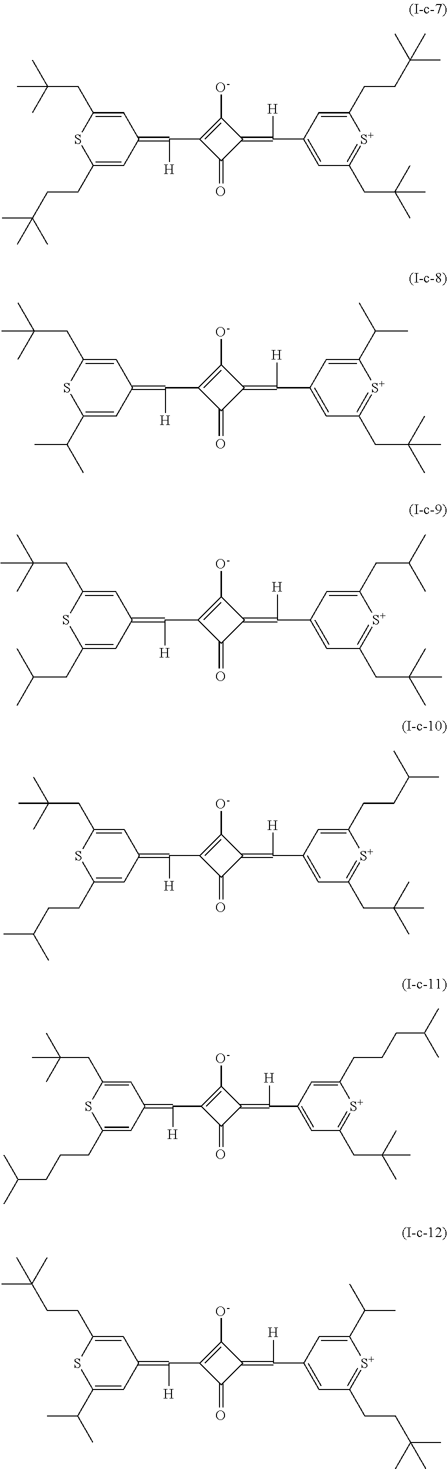

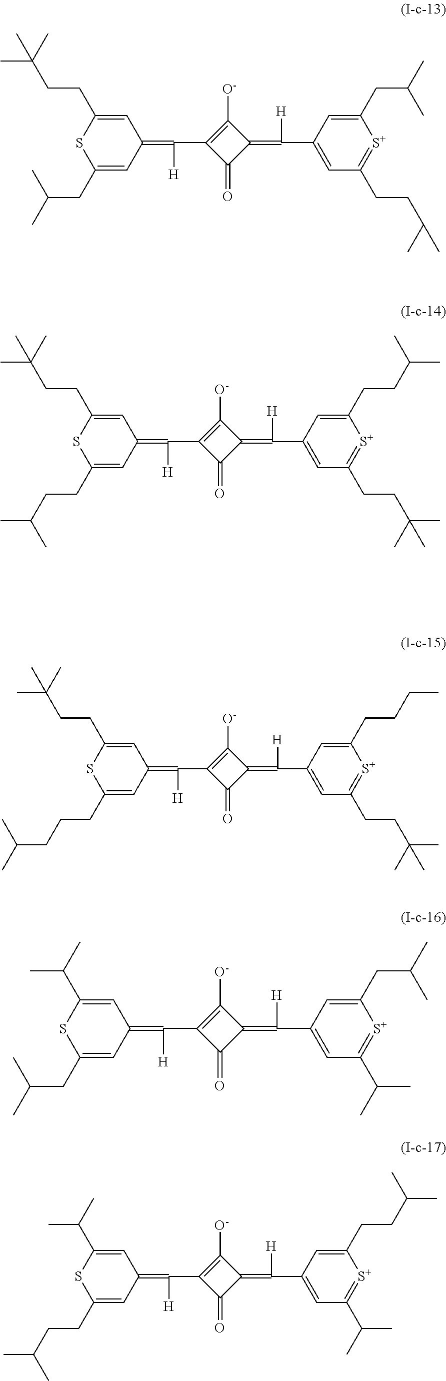

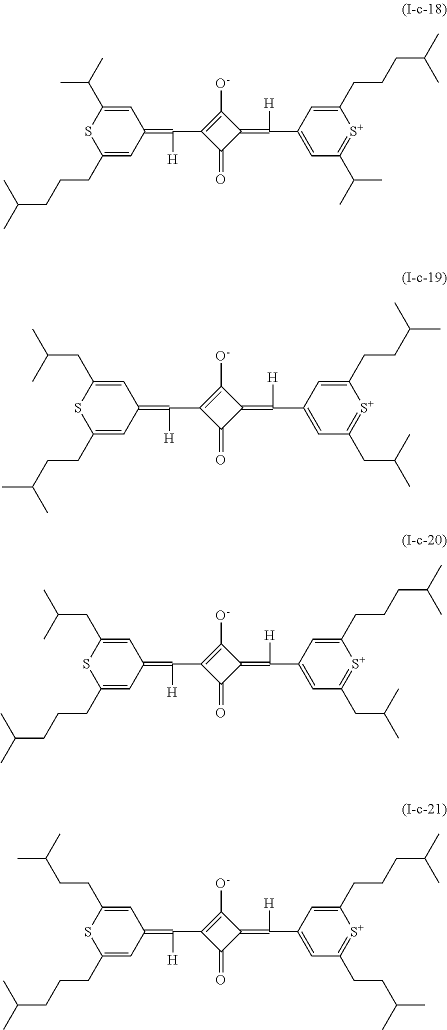

Next, specific examples which have two groups represented by Formula (I-R) are shown.

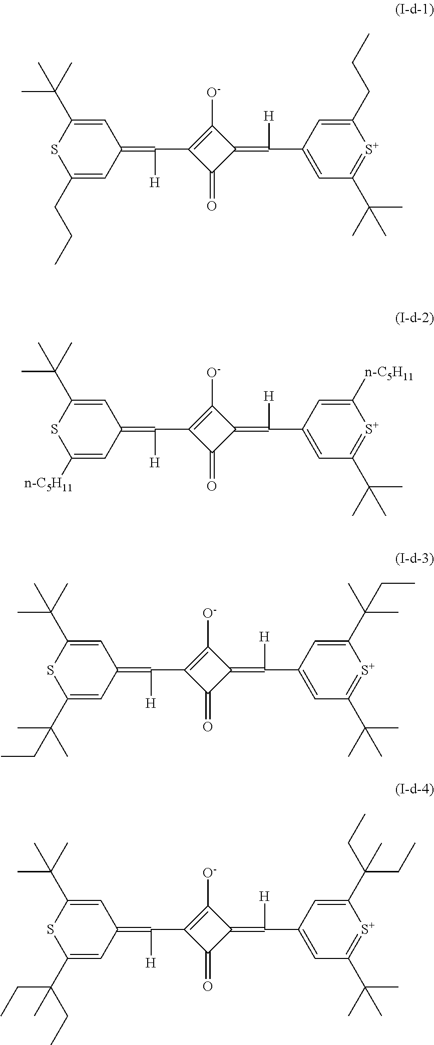

Among the specific examples of the compound represented by Formula (I) described above, Exemplary Compounds (I-a-1) to (I-a-7), (I-b-1) to (I-b-6), and (I-c-1) to (I-c-6) are preferable. Furthermore, Exemplary Compounds (I-a-1), (I-b-3), (I-c-3) are more preferable, and Exemplary Compound (I-a-1) is most preferable.

One example of the synthetic method of the compound represented by Formula (I) will be described.

Case of Compound in Which all of R^{a} to R^{d} Have Same Structures

The compound represented by Formula (I) is synthesized, for example, according to the following Scheme 1. Here, Scheme 1 shows a synthetic pathway of a compound (I)-A in which all of R^{a} to R^{d} in Formula (I) are the groups represented by Formula (I-R), having the same structures.

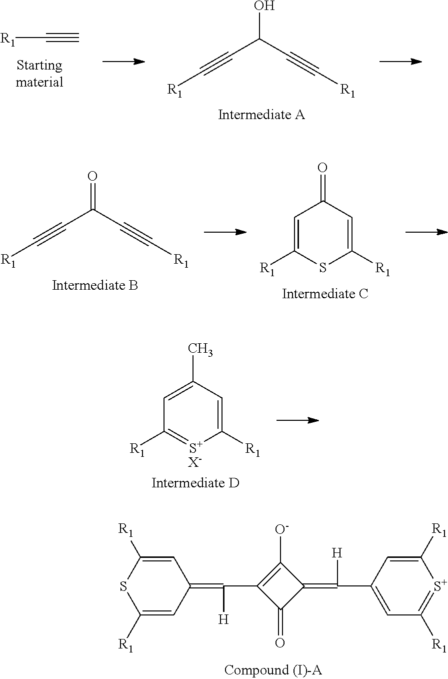

First, in an inert atmosphere and under cooling, the starting material 1 is added dropwise to an organic solvent (for example, tetrahydrofuran) solution of an organomagnesium halide (for example, a Grignard reagent such as ethylmagnesium chloride) to act. Thereafter, to complete the reaction, the temperature may be returned to room temperature (for example, 23° C. to 25° C.) or a higher temperature than room temperature. Next, a formic acid derivative (for example, ethyl formate) is added dropwise thereto to act under cooling. Thereafter, to complete the reaction, the temperature may be returned to room temperature (for example, 23° C. to 25° C.) or a higher temperature than room temperature. The organic material is extracted from the reaction-finished mixture, whereby an intermediate A is obtained from the separated organic layer.

Next, the intermediate A and an oxidation reagent (for example, manganese oxide) are added to a solvent (for example, cyclohexane), followed by refluxing while heating to perform the reaction. The water generated during the reaction may be removed. An intermediate B is obtained from the organic layer of the reaction mixture. Moreover, purification may be performed when obtaining the intermediate B.

Next, the intermediate B is subjected to a cycloaddition reaction. For example, sodium monohydrogensulfide n-hydrate is added to a solvent (for example, ethanol), and the intermediate B is added dropwise thereto under cooling. Thereafter, after the resultant product is reacted at room temperature (for example, 23° C. to 25° C.), the solvent is removed from the reaction liquid, then, sodium chloride is added until saturation, and the organic phase is collected by liquid-liquid separation, whereby an intermediate C is obtained from the organic phase. Moreover, purification may be performed when obtaining the intermediate C.

Next, in an inert gas atmosphere, a solvent (for example, anhydrous tetrahydrofuran) and the intermediate C are mixed, and a Grignard reagent (for example, methylmagnesium bromide) is added dropwise thereto. After the dropping ends, the reaction liquid is heated to reflux, and ammonium bromide is added dropwise thereto under cooling. The separated organic layer is dried and concentrated, whereby an intermediate D is obtained.

Next, in an inert atmosphere, the intermediate D and squaric acid are dispersed in a solvent (for example, a mixed solvent of cyclohexane and isobutanol), and a basic compound (for example, pyridine) is added thereto, followed by ref luxing while heating, whereby a compound (I)-A is obtained. The water generated during the reaction may be removed. In addition, purification, isolation, or concentration may be performed.

Case of Compound in Which R^{a} and R^{d} Have Same Structures and R^{b} and R^{c} Have Same Structures

Next, a synthetic pathway of a compound in which R^{a} and R^{d} in Formula (I) are groups having the same structures, and R^{b} and R^{c} are groups having the same structures, and different from R^{a} and R^{d} will be shown.

The compound is synthesized by changing the synthesis method of the intermediate A in the compound (I)-A to the method shown in the following Scheme 2.

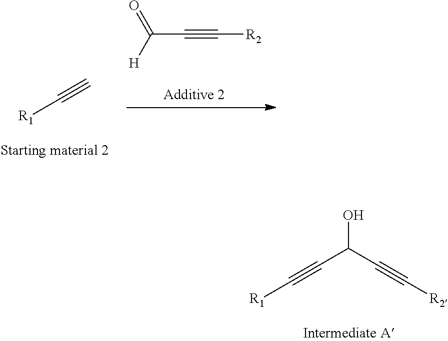

In Scheme 2, first, a starting material 2 and an additive 2 are added to a Grignard reagent (organic solution (for example, a THF solution) in which (for example, ethylmagnesium bromide) is added) to react. A strong acid (for example, hydrochloric acid) is added to the solution after the reaction under cooling, and then, ether is added thereto at room temperature (for example, 23° C. to 25° C.), whereby an intermediate A′ is obtained from the organic layer. Moreover, purification may be performed when obtaining the intermediate A′.

Thereafter, a compound is synthesized in the same manner except that the intermediate A shown in Scheme 1 is changed to the intermediate A′.

Case of Compound in Which R^{a} and R^{b} Have Same Structures and R^{c} and R^{d} Have Same Structures

Synthesis of a compound in which R^{a} and R^{b} in Formula (I) are groups having the same structures and R^{c} and R^{d} are groups having the same structures and are different from R^{a} and R^{b} is performed by preparing two types of compounds having different structures of R₁ in the intermediate D in the compound (I)-A, performing synthesis in the same manner as Scheme 1 using the two types of intermediate D's, and purifying the obtained compound.

In addition, a compound in which three of R^{a} to R^{d} have the same structures, a compound in which two of R^{a} to R^{d} have the same structures and the other two respectively have different structures, and a compound in which all of R^{a} to R^{d} have different structures may also be synthesized according to the preparation methods shown in Schemes 1 and 2.

The maximum absorption wavelength of the compound represented by Formula (I) in a tetrahydrofuran (THF) solution may be within a range from 760 nm to 1200 nm, preferably within a range from 780 nm to 1100 nm, and more preferably within a range from 800 nm to 1,000 nm.

The molar absorption coefficient at the maximum absorption wavelength of the compound represented by Formula (I) in a tetrahydrofuran (THF) solution may be 100,000 Lmol⁻¹cm⁻¹ to 600,000 Lmol⁻¹ cm⁻¹, preferably 200,000 Lmol⁻¹cm⁻¹ to 600,000 Lmol⁻¹cm⁻¹, and more preferably 250,000 Lmol⁻¹ cm⁻¹ to 600,000 Lmol⁻¹cm⁻¹.

The compound represented by Formula (I) may preferably be present in the resin composition in a solid dispersion state. In a case where the compound represented by Formula (I) is present in the resin composition in a solid dispersion state, the weight average particle diameter thereof may be from 10 nm to 1000 nm, preferably from 10 nm to 500 nm, and more preferably from 20 nm to 300 nm.

Moreover, the compound represented by Formula (I) may be present in the resin composition in a molecular dispersion state dispersing at a molecular level.

The resin composition according to the exemplary embodiment may further include a known infrared absorbent in addition to the compound represented by Formula (I). For example, in a case where the resin composition is used in an electrostatic charge image developing toner, a known infrared absorbent may be used in combination within a range that does not affect the fixability.

Examples of the known infrared absorbent which may be used include a cyanine compound, a merocyanine compound, a benzenethiol metal complex, a mercaptophenol metal complex, an aromatic diamine metal complex, a diimonium compound, an aminium compound, a nickel complex compound, a phthalocyanine compound, an anthraquinone compound, a naphthalocyanine compound, or a croconium compound.

Specific examples of the known infrared absorbents include nickel metal complex infrared absorbents (SIR-130 and SIR-132, manufactured by Mitsui Chemicals, Inc.), bis(dithiobenzyl)nickel (MIR-101, manufactured by Midori Kagaku Co., Ltd.), bis[1,2-bis(p-methoxyphenyl)-1,2-ethylenedithiolate]nickel (MIR-102, manufactured by Midori Kagaku Co., Ltd.), tetra-n-butylammonium bis(cis-1,2-diphenyl-1,2-ethylenedithiolate)nickel (MIR-1011, manufactured by Midori Kagaku Co., Ltd.), tetra-n-butylammonium bis[1,2-bis(p-methoxyphenyl)-1,2-ethylenedithiolate]nickel (MIR-1021, manufactured by Midori Kagaku Co., Ltd.), bis(4-tert-1,2-butyl-1,2-dithiophenolate)nickel-tetra-n-bu tylammonium (BBDT-NI, manufactured by Sumitomo Seika Chemicals Co., Ltd.), cyanine infrared absorbents (IRF-106 and IRF-107, manufactured by FUJIFILM (registered trademark)), a cyanine infrared absorbent (YKR2900, manufactured by Yamamoto Chemicals Inc.), aminium and diimonium infrared absorbent (NIR-AM1 and IM1, manufactured by Nagase ChemteX Corporation), immonium compounds (CIR-1080 and CIR-1081, manufactured by Japan Carlit Co., Ltd.), aminium compounds (CIR-960 and CIR-961, manufactured by Japan Carlit Co., Ltd), an anthraquinone compound (IR-750, manufactured by Nippon Kayaku Co., Ltd.), an aminium compound (IRG-002, IRG-003, and IRG-003K, manufactured by Nippon Kayaku Co., Ltd.), a polymethine compound (IR-820B, manufactured by Nippon Kayaku Co., Ltd.), diimonium compounds (IRG-022 and IRG-023, manufactured by Nippon Kayaku Co., Ltd.), dianine compounds (CY-2, CY-4, and CY-9, manufactured by Nippon Kayaku Co., Ltd.), a soluble phthalocyanine (TX-305A, manufactured by Nippon Shokubai Co., Ltd.), naphthalocyanine (YKR5010, manufactured by Yamamoto Chemicals Inc. and Sample 1 manufactured by Sanyo Color Works, LTD.), and inorganic materials (ytterbium UU-HP, manufactured by Shin-Etsu Chemical Co., Ltd. and indium tin oxide, manufactured by Sumitomo Metal Industries, Ltd.).

Among these, a diimonium compound or a croconium compound is preferable.

Other Components

Moreover, the resin composition may include other components depending on the purpose. As other components, various known additives are exemplified, and examples thereof include a plasticizer, a dispersant, a viscosity modifier, a pH adjusting agent, an antioxidant, a preservative, a fungicide, an organic solvent, and a pigment.

Preparation Method for Resin Composition

The preparation method for the resin composition according to the exemplary embodiment is not particularly limited.

Examples of the method include a method of dissolving or dispersing the specific infrared absorbent, a resin, and as necessary, other components; a method of dispersing a resin so as to become particulate in a solution, of adding the specific infrared absorbent and as necessary, other materials thereto, and of aggregating these together; a method of polymerizing a monomer which is the raw material of a resin in a solution in which the specific infrared absorbent and as necessary, other materials coexist; and a method of molten-kneading the specific infrared absorbent, a resin, and as necessary, other materials together, and of forming or pulverizing, in a case where the resin is a thermoplastic resin.

Use of Resin Composition

Use of the resin composition is not particularly limited, and specific examples thereof include a paint for a heating element which generates heat by absorption of infrared light and a filter film forming composition for an infrared filter which transmits visible light and shields infrared light, in addition to an image forming material such as toner described below.

Electrostatic Charge Image Developing Toner

Next, the electrostatic charge image developing toner according to the exemplary embodiment will be described.

The electrostatic charge image developing toner according to the exemplary embodiment (hereinafter, also simply referred to as “toner”) includes the resin composition according to the exemplary embodiment. The toner according to the exemplary embodiment is configured to include toner particles, and as necessary, an external additive, but the resin composition according to the exemplary embodiment is preferably contained in the toner particles.

That is, in a case where toner particles contains the resin composition according to the first aspect, the toner particles, for example, include the specific polyester resin as a binder resin, and include the specific infrared absorbent (compound represented by Formula (I)) as an infrared absorbent.

In addition, in a case where toner particles contains the resin composition according to the second aspect, the toner particles, for example, include the specific acrylic resin as a binder resin, and include the specific infrared absorbent (compound represented by Formula (I)) as an infrared absorbent.

The content of the compound represented by Formula (I) in the toner particles is preferably from 0.01% by weight to 5% by weight, more preferably from 0.01% by weight to 1% by weight, and still more preferably from 0.01% by weight to 0.5% by weight, with respect to the total weight of the toner particles.

The content of the binder resin in the toner particles is, for example, preferably from 40% by weight to 95% by weight, more preferably from 50% by weight to 90% by weight, and still more preferably from 60% by weight to 85% by weight, with respect to the total toner particles.

Toner Particles

The toner particles are configured to include, for example, a colorant, a release agent, or other additives, in addition to the resin composition according to the exemplary embodiment.

Colorant

Examples of the colorant include various pigments such as carbon black, chrome yellow, hansa yellow, benzidine yellow, threne yellow, quinoline yellow, pigment yellow, permanent orange GTR, pyrazolone orange, vulcan orange, watching red, permanent red, brilliant carmine 3B, brilliant carmine 6B, DuPont oil red, pyrazolone red, lithol red, rhodamine B lake, lake red C, pigment red, rose bengal, aniline blue, ultramarine blue, calco oil blue, methylene blue chloride, phthalocyanine blue, pigment blue, phthalocyanine green, and malachite green oxalate, and various dyes such as an acridine dye, a xanthene dye, an azo dye, a benzoquinone dye, an azine dye, an anthraquinone dye, a thioindigo dye, a dioxazine dye, a thiazine dye, an azomethine dye, an indigo dye, a phthalocyanine dye, an aniline black dye, a polymethine dye, a triphenylmethane dye, a diphenylmethane dye, and a thiazole dye.

The colorants may be used alone or in combination of two or more types thereof.

As the colorant, a surface-treated colorant may be used as necessary, or the colorant may be used in combination with a dispersant. In addition, plural types of colorants may be used in combination.

The content of the colorant is, for example, preferably from 1% by weight to 30% by weight, and more preferably from 3% by weight to 15% by weight, with respect to the total toner particles.

Release Agent

Examples of the release agent include hydrocarbon waxes; natural waxes such as a carnauba wax, a rice wax, and a candelilla wax; synthetic or mineral-petroleum waxes such as a montan wax; and ester waxes such as fatty acid ester and montanic acid ester. However, the release agent is not limited thereto.

The melting temperature of the release agent is preferably 50° C. to 110° C., and more preferably 60° C. to 100° C.

The melting temperature is obtained from “melting peak temperature” described in the method for determining a melting temperature in JIS K7121-1987 “Testing Methods for Transition Temperatures of Plastics”, from a DSC curve obtained by differential scanning calorimetry (DSC).

The content of the release agent is, for example, preferably from 1% by weight to 20% by weight, and more preferably from 5% by weight to 15% by weight, with respect to the total toner particles.

Other Additives

As other additives, known additives such as a magnetic material, a charge-controlling agent, and inorganic powder are exemplified. These additives are included in the toner particles as an internal additive.

Characteristics or the Like of Toner Particles

The toner particles may be toner particles having a single layer structure, or toner particles having a so-called core/shell structure configured of a core (core particle) and a coating layer (shell layer) with which the core is coated.

Here, the toner particles having the core/shell structure may be configured to have a core configured to include a binder resin, the compound represented by Formula (I), and as necessary, other additives such as a colorant and a release agent, and a coating layer configured to include a binder resin.

The volume average particle diameter (D50v) of the toner particles is preferably 2 μm to 10 μm, and more preferably 4 μm to 8 μm.

Moreover, various average particle diameters and various particle diameter distribution indexes of the toner particles are measured using a Coulter Multisizer II (manufactured by Beckman Coulter, Inc.), and ISOTON-II (manufactured by Beckman Coulter, Inc.) as an electrolyte.

In the measurement, from 0.5 mg to 50 mg of a measurement sample is added to 2 ml of a 5% aqueous solution of a surfactant (preferably, sodium alkylbenzene sulfonate) as a dispersant. The resultant product is added to from 100 ml to 150 ml of the electrolyte.

The electrolyte in which the sample is suspended is subjected to a dispersion treatment using an ultrasonic disperser for 1 minute, and a particle diameter distribution of particles having a particle diameter of 2 μm to 60 μm is measured by a Coulter Multisizer II using an aperture having an aperture diameter of 100 μm. Moreover, 50,000 particles are sampled.

Cumulative distributions by volume and by number are drawn from the side of the smallest diameter with respect to particle diameter ranges (channels) divided based on the measured particle diameter distribution. The particle diameter when the cumulative percentage becomes 16% is defined as that corresponding to a volume particle diameter D16v and a number particle diameter D16p, while the particle diameter when the cumulative percentage becomes 50% is defined as that corresponding to a volume average particle diameter D50v and a number average particle diameter D50p. Furthermore, the particle diameter when the cumulative percentage becomes 84% is defined as that corresponding to a volume particle diameter D84v and a number particle diameter D84p.

Using these, a volume average particle diameter distribution index (GSDv) is calculated as (D84v/D16v)^{1/2}, while a number average particle diameter distribution index (GSDp) is calculated as (D84p/D16p)^{1/2}.

The shape factor SF1 of the toner particles is preferably from 110 to 150, and more preferably from 120 to 140.

Moreover, the shape factor SF1 is determined by the following equation.

SF1=(ML²/A)×(π/4)×100 Equation:

In the above equation, ML represents an absolute maximum length of a toner particle, and A represents a projected area of a toner particle.

Specifically, the shape factor SF1 is numerically converted mainly by analyzing a microscopic image or a scanning electron microscopic (SEM) image by the use of an image analyzer, and is calculated as follows. That is, an optical microscopic image of particles scattered on a surface of a glass slide is input to an image analyzer Luzex through a video camera to obtain maximum lengths and projected areas of 100 particles, values of SF1 are calculated by the above equation, and an average value thereof is obtained.

External Additive

Examples of the external additive include inorganic particles. Examples of the inorganic particles include SiO₂, TiO₂, Al₂O₃, CuO, ZnO, SnO₂, CeO₂, Fe₂O₃, MgO, BaO, CaO, K₂O, Na₂O, ZrO₂, CaO.SiO₂, K₂O—(TiO₂)n, Al₂O₃.2SiO₂, CaCO₃, MgCO₃, BaSO₄, and MgSO₄.

The surfaces of the inorganic particles as an external additive may preferably be treated with a hydrophobizing agent. The treatment with a hydrophobizing agent is performed by, for example, dipping the inorganic particles in a hydrophobizing agent. The hydrophobizing agent is not particularly limited, and examples thereof include a silane coupling agent, silicone oil, a titanate coupling agent, and an aluminum coupling agent. These may be used alone or in combination of two or more types thereof.

Typically, the amount of the hydrophobizing agent is, for example, from 1 part by weight to 10 parts by weight with respect to 100 parts by weight of the inorganic particles.

Examples of the external additive also include resin particles (resin particles such as polystyrene particles, polymethyl methacrylate (PMMA) particles, or melamine resin particles) and a cleaning aid (for example, a metal salt of higher fatty acid represented by zinc stearate or particles of a fluorine high molecular weight material).

The amount of external additive externally added is, for example, preferably from 0.01% by weight to 5% by weight, and more preferably from 0.01% by weight to 2.0% by weight, with respect to the toner particles.

Method of Preparing Toner

Next, a preparation method of toner according to the exemplary embodiment will be described.

The toner according to the exemplary embodiment is obtained by externally adding an external additive to toner particles after preparation of the toner particles.

The toner particles may be prepared using any of a dry preparation method (for example, a kneading and pulverizing method) and a wet preparation method (for example, an aggregation and coalescence method, a suspension and polymerization method, and a dissolution and suspension method). The preparation method of toner particles is not particularly limited to these preparation methods, and a known preparation method is employed.

Among these, toner particles may preferably be obtained by the aggregation and coalescence method.

Specifically, for example, in a case where the toner particles are prepared by the aggregation and coalescence method, the toner particles are prepared through the processes of: preparing a resin particle dispersion in which resin particles as a binder resin are dispersed (resin particle dispersion preparation process); aggregating the resin particles (as necessary, other particles) in the resin particle dispersion (as necessary, in the dispersion after mixing with other particle dispersions) to form aggregated particles (aggregated particle forming process); and forming toner particles by heating the aggregated particle dispersion in which the aggregated particles are dispersed to coalesce the aggregated particles (coalescence process).

In the exemplary embodiment, at least a dispersion in which at least the compound (infrared absorbent) represented by Formula (I) is dispersed is used as other particle dispersions described above.

Hereinafter, each process will be described in detail.

Moreover, in the following description, a method of obtaining toner particles including a colorant and a release agent will be described, but the colorant and the release agent are used as necessary. Other additives than the colorant and the release agent may also be used.

Resin Particle Dispersion Preparation Process

First, for example, a colorant particle dispersion in which colorant particles are dispersed and a release agent particle dispersion in which release agent particles are dispersed are prepared together with a resin particle dispersion in which resin particles as a binder resin are dispersed and an infrared absorbent dispersion in which the compound (infrared absorbent) represented by Formula (I) is dispersed.

Here, the resin particle dispersion is prepared by, for example, dispersing resin particles by a surfactant in a dispersion medium.

Examples of the dispersion medium used for the resin particle dispersion include aqueous mediums.

Examples of the aqueous mediums include water such as distilled water and ion exchange water, and alcohols. These may be used alone or in combination of two or more types thereof.

Examples of the surfactant include anionic surfactants such as a sulfuric ester salt anionic surfactant, a sulfonate anionic surfactant, a phosphate ester anionic surfactant, and a soap anionic surfactant; cationic surfactants such as an amine salt cationic surfactant and a quaternary ammonium salt cationic surfactant; and nonionic surfactants such as a polyethylene glycol nonionic surfactant, an alkyl phenol ethylene oxide adduct nonionic surfactant, and a polyol nonionic surfactant. Among these, anionic surfactants or cationic surfactants are particularly preferable. The nonionic surfactant may be used in combination with an anionic surfactant or a cationic surfactant.

The surfactants may be used alone or in combination of two or more types thereof.

Regarding the resin particle dispersion, as a method for dispersing the resin particles in the dispersion medium, a common dispersing method using, for example, a rotary shearing-type homogenizer, or a ball mill, a sand mill, or a Dyno mill having media is exemplified. In addition, depending on the type of the resin particles, resin particles may be dispersed in the resin particle dispersion using, for example, a phase inversion emulsification method.

The phase inversion emulsification method includes: dissolving a resin to be dispersed in a hydrophobic organic solvent in which the resin is soluble; conducting neutralization by adding a base to an organic continuous phase (O phase); and converting the resin (so-called phase inversion) from W/O to O/W by putting an aqueous medium (W phase) to form a discontinuous phase, thereby dispersing the resin as particles in the aqueous medium.

The volume average particle diameter of the resin particles dispersed in the resin particle dispersion is, for example, preferably from 0.01 μm to 1 μm, more preferably from 0.08 μm to 0.8 μm, and still more preferably from 0.1 μm to 0.6 μm.

Moreover, regarding the volume average particle diameter of the resin particles, a cumulative distribution by volume is drawn from the side of the smallest diameter with respect to particle diameter ranges (channels) divided using the particle diameter distribution obtained by the measurement of a laser diffraction-type particle diameter distribution measuring apparatus (for example, LA-700, manufactured by Horiba, Ltd.), and a particle diameter when the cumulative percentage becomes 50% with respect to the entirety of the particles is measured as a volume average particle diameter D50v. Moreover, the volume average particle diameter of the particles in other dispersions is also measured in the same manner.

The content of the resin particles included in the resin particle dispersion is, for example, preferably from 5% by weight to 50% by weight, and more preferably from 10% by weight to 40% by weight.

In the same manner as the resin particle dispersion, for example, an infrared absorbent dispersion in which the compound (infrared absorbent) represented by Formula (I) is dispersed, a colorant particle dispersion, and a release agent particle dispersion are also prepared. That is, the particles in the resin particle dispersion are the same as the compound (infrared absorbent) represented by Formula (I) dispersed in the infrared absorbent dispersion, the colorant particles dispersed in the colorant particle dispersion, and the release agent particles dispersed in the release agent particle dispersion, in terms of the volume average particle diameter, the dispersion medium, the dispersing method, and the content of the particles.

Aggregated Particle Forming Process

Next, the infrared absorbent dispersion, the colorant particle dispersion, and the release agent particle dispersion are mixed together with the resin particle dispersion.

The resin particles, the infrared absorbent, the colorant particles, and the release agent particles are heterogeneously aggregated in the mixed dispersion, thereby forming aggregated particles having a diameter near a target toner particle diameter and including the resin particles, the infrared absorbent, the colorant particles, and the release agent particles.

Specifically, for example, an aggregating agent is added to the mixed dispersion and a pH of the mixed dispersion is adjusted to acidity (for example, the pH is from 2 to 5). As necessary, a dispersion stabilizer is added. Then, the mixed dispersion is heated to a temperature of the glass transition temperature of the resin particles (specifically, for example, from a temperature 30° C. lower than the glass transition temperature to a temperature 10° C. lower than the glass transition temperature of the resin particles) to aggregate the particles dispersed in the mixed dispersion, thereby forming the aggregated particles.

In the aggregated particle forming process, for example, the aggregating agent may be added at room temperature (for example, 25° C.) under stirring of the mixed dispersion using a rotary shearing-type homogenizer, the pH of the mixed dispersion may be adjusted to acidity (for example, the pH is from 2 to 5), a dispersion stabilizer may be added as necessary, and the heating may then be performed.

Examples of the aggregating agent include a surfactant having an opposite polarity to the polarity of the surfactant used as the dispersant to be added to the mixed dispersion, such as inorganic metal salts and di- or higher valent metal complexes. Particularly, when a metal complex is used as the aggregating agent, the amount of the surfactant used is reduced and charging characteristics are improved.

If necessary, an additive may be used which forms a complex or a similar bond with the metal ions of the aggregating agent. A chelating agent is preferably used as the additive.

Examples of the inorganic metal salts include metal salts such as calcium chloride, calcium nitrate, barium chloride, magnesium chloride, zinc chloride, aluminum chloride, and aluminum sulfate, and inorganic metal salt polymers such as polyaluminum chloride, polyaluminum hydroxide, and calcium polysulfide

A water-soluble chelating agent may be used as the chelating agent. Examples of the chelating agent include oxycarboxylic acids such as tartaric acid, citric acid, and gluconic acid, iminodiacetic acid (IDA), nitrilotriacetic acid (NTA), and ethylenediaminetetraacetic acid (EDTA).

The amount of the chelating agent added is, for example, preferably from 0.01 parts by weight to 5.0 parts by weight, and more preferably equal to or greater than 0.1 parts by weight and less than 3.0 parts by weight, with respect to 100 parts by weight of the resin particles.

Coalescence Process

Next, the aggregated particle dispersion in which the aggregated particles are dispersed is heated to, for example, a temperature that is equal to or higher than the glass transition temperature of the resin particles (for example, equal to or higher than a temperature that is 10° C. to 30° C. higher than the glass transition temperature of the resin particles) to coalesce the aggregated particles and form toner particles.

Toner particles are obtained through the above processes.

After the aggregated particle dispersion in which the aggregated particles are dispersed is obtained, toner particles may be prepared through the processes of: further mixing the resin particle dispersion in which the resin particles are dispersed with the aggregated particle dispersion to conduct aggregation so that the resin particles further attach to the surfaces of the aggregated particles, thereby forming second aggregated particles; and coalescing the second aggregated particles by heating the second aggregated particle dispersion in which the second aggregated particles are dispersed, thereby forming toner particles having a core/shell structure.

After the coalescence process ends, the toner particles formed in the solution are subjected to a washing process, a solid-liquid separation process, and a drying process, that are well known, and thus dry toner particles are obtained.

In the washing process, preferably, displacement washing using ion exchange water is sufficiently performed from the viewpoint of charging properties. In addition, the solid-liquid separation process is not particularly limited, but suction filtration, pressure filtration, or the like may be preferably performed from the viewpoint of productivity. The method of the drying process is also not particularly limited, but freeze drying, flash jet drying, fluidized drying, vibration-type fluidized drying, or the like may be preferably performed from the viewpoint of productivity.

The toner according to the exemplary embodiment is prepared by, for example, adding an external additive and mixing with dry toner particles that have been obtained. The mixing may be preferably performed using, for example, a V-blender, a Henschel mixer, a Lödige mixer, or the like. Furthermore, as necessary, coarse toner particles may be removed using a vibration sieving machine, a wind classifier, or the like.

Electrostatic Charge Image Developer

The electrostatic charge image developer according to the exemplary embodiment includes at least the toner according to the exemplary embodiment.

The electrostatic charge image developer according to the exemplary embodiment may be a single-component developer including only the toner according to the exemplary embodiment, or a two-component developer obtained by mixing the toner with a carrier.

The carrier is not particularly limited, and known carriers are exemplified. Examples of the carrier include a coated carrier in which surfaces of cores formed of magnetic particles are coated with a coating resin; a magnetic particle dispersion-type carrier in which the magnetic particles are dispersed and blended in a matrix resin; and a resin impregnation-type carrier in which porous magnetic particles are impregnated with a resin.

Moreover, the magnetic particle dispersion-type carrier and the resin impregnation-type carrier may be carriers in which constituent particles of the carrier are cores and have a surface coated with a coating resin.

Examples of the magnetic particles include magnetic metals such as iron, nickel, and cobalt, and magnetic oxides such as ferrite and magnetite.

Examples of the coating resin and the matrix resin include polyethylene, polypropylene, polystyrene, polyvinyl acetate, polyvinyl alcohol, polyvinyl butyral, polyvinyl chloride, polyvinyl ether, polyvinyl ketone, a vinyl chloride-vinyl acetate copolymer, a styrene-acrylic acid copolymer, a straight silicone resin configured to include an organosiloxane bond or a modified product thereof, a fluororesin, polyester, polycarbonate, a phenol resin, and an epoxy resin.

Moreover, the coating resin and the matrix resin may include other additives such as a conductive particle.

Examples of the conductive particles include particles of metals such as gold, silver, and copper, carbon black particles, titanium oxide particles, zinc oxide particles, tin oxide particles, barium sulfate particles, aluminum borate particles, and potassium titanate particles.

Here, a coating method using a coating layer forming solution in which a coating resin and, as necessary, various additives are dissolved in an appropriate solvent is used to coat the surface of a core with the coating resin. The solvent is not particularly limited, and may be selected in consideration of the type of coating resin to be used, coating suitability, and the like.

Specific examples of the resin coating method include a dipping method of dipping cores in a coating layer forming solution; a spraying method of spraying a coating layer forming solution to surfaces of cores; a fluid bed method of spraying a coating layer forming solution in a state in which cores are allowed to float by flowing air; and a kneader-coater method in which cores of a carrier and a coating layer forming solution are mixed with each other in a kneader-coater and the solvent is removed.

The mixing ratio (weight ratio) between the toner and the carrier in the two-component developer is preferably from 1:100 to 30:100, and more preferably from 3:100 to 20:100 (toner:carrier).

Applications

The toner according to the exemplary embodiment may be a toner for light fixing, or may be a toner for heat fixing, but, in particular, is suitably used as a toner for light fixing. In addition, the toner according to the exemplary embodiment may be a colored toner including a colorant, or may be a transparent toner (so-called invisible toner) not including a colorant. Here, the invisible toner is, for example, a toner for forming an image for being decoded (read) using invisible light such as infrared rays, and means a toner which is less likely to be visually recognized (ideally, never recognized) in a case where a toner image is fixed on a recording medium (for example, paper, or the like).

Moreover, the invisible toner may include a colorant as long as the amount of the colorant added is at a level in which the presence of the colorant is unrecognized (for example, 1% by weight or less).

Image Forming Apparatus and Image Forming Method

Next, the image forming apparatus and the image forming method according to the exemplary embodiment using the toner according to the exemplary embodiment will be described.

The image forming apparatus according to the exemplary embodiment is provided with an image holding member, a charging unit that charges a surface of the image holding member, an electrostatic charge image forming unit that forms an electrostatic charge image on a charged surface of the image holding member, a developing unit that accommodates the electrostatic charge image developer according to the exemplary embodiment and develops the electrostatic charge image formed on the surface of the image holding member with the electrostatic charge image developer to forma toner image, a transfer unit that transfers the toner image formed on the surface of the image holding member onto a surface of a recording medium, and a fixing unit that fixes the toner image transferred onto the surface of the recording medium.

With the image forming apparatus according to the exemplary embodiment, an image forming method including a charging process of charging a surface of an image holding member, an electrostatic charge image forming process of forming an electrostatic charge image on the charged surface of the image holding member, a developing process of developing the electrostatic charge image formed on the surface of the image holding member with the electrostatic charge image developer according to the exemplary embodiment to form a toner image, a transfer process of transferring the toner image formed on the surface of the image holding member onto a surface of a recording medium, and a fixing process of fixing the toner image transferred onto the surface of the recording medium is provided.

In a case where an electrophotographic photoreceptor (hereinafter, referred to as “photoreceptor”) is used as an image holding member, formation of an image in the image forming apparatus according to the exemplary embodiment is, for example, performed as follows. First, the surface of a photoreceptor is charged using a corotron charger, a contact charger, or the like, and exposed to light, whereby an electrostatic charge image is formed. Next, the electrostatic charge image is brought into contact with or approached to a developing roll having a developer layer formed on the surface thereof, and due to this, toner is attached to the electrostatic charge image, whereby a toner image is formed on the photoreceptor. The formed toner image is transferred onto the surface of a recording medium such as paper using a corotron charger or the like. Furthermore, the toner image transferred onto the surface of the recording medium is fixed by a fixing device, whereby an image is formed on the recording medium.

As the photoreceptor, in general, an inorganic photoreceptor such as amorphous silicon or selenium, or an organic photoreceptor using polysilane, phthalocyanine, or the like as a charge generating material or a charge transport material is used. In particular, as the photoreceptor, in the case of an inorganic photoreceptor, amorphous silicon photoreceptor is preferable, and in the case of an organic photoreceptor, a photoreceptor having a so-called overcoat layer, which is a resin layer having a crosslinked structure such as a melamine resin, a phenolic resin, or a silicone resin on the outermost surface layer is preferable, from the viewpoint of abrasion resistance.

As the toner, in the case of using a positive charge toner, in general, an inorganic photoreceptor represented by amorphous silicon (sometimes, also abbreviated as “a-Si”) is used, and in the case of using a negative charge toner, in general, an organic photoreceptor is used.

In the image forming apparatus and the image forming method in the exemplary embodiment, fixing of a toner image onto a recording medium is preferably performed by light fixing by light irradiation. Moreover, pressure-heat-fixing using a heating member and light fixing by light irradiation may be used in combination.

The fixing unit for employing a light fixing method for fixing by irradiation of a toner image with light may be a unit which performs fixing by light, and a light fixing device (flash fixing device) is used.

Examples of the light source used in the light fixing device include a typical halogen lamp, a mercury lamp, a flash lamp, and an infrared laser.

As the heating member, a heating roll fuser, an oven fuser, or the like is preferably used.

As the heating roll fuser, a heating roll type fixing device in which a pair of fixing rolls are arranged so as to be pressed against each other is used. For the pair of fixing rolls, a heating roll and a pressure roll are provided to face each other, and a nip is formed by press-contact therebetween. The heating roll may be prepared by forming an elastic member layer (elastic layer) having heat resistance and oil resistance and a surface layer formed of a fluorine resin or the like sequentially on a metallic hollow core having a heater lamp therein, and the pressure roll may be prepared by forming an elastic member layer having heat resistance and oil resistance and a surface layer are sequentially formed at a metallic hollow core having a heater lamp therein as necessary. By passing a recording medium on which a toner image is formed through a nip region formed by the heating roll and the pressure roll, the toner image is fixed.

Among these, the fixing unit may preferably be a device that emits an infrared laser emitting laser light of 860 nm or greater. It is because the infrared laser has excellent energy conversion efficiency, that is, luminous efficiency, and is likely to reduce the energy required for the fixing unit.

In addition, the infrared absorbent represented by Formula (I) has a maximum absorption wavelength in the wavelength region of 860 nm or greater, absorption efficiency of the infrared laser light by the infrared absorbent is improved, and the amount of the infrared absorbent which is added to a toner is easily reduced.

Hereinafter, an example of the image forming apparatus according to the exemplary embodiment will be described, but the image forming apparatus is not limited thereto. Moreover, major portions shown in the FIGURE will be described, and description of other portions will be omitted.

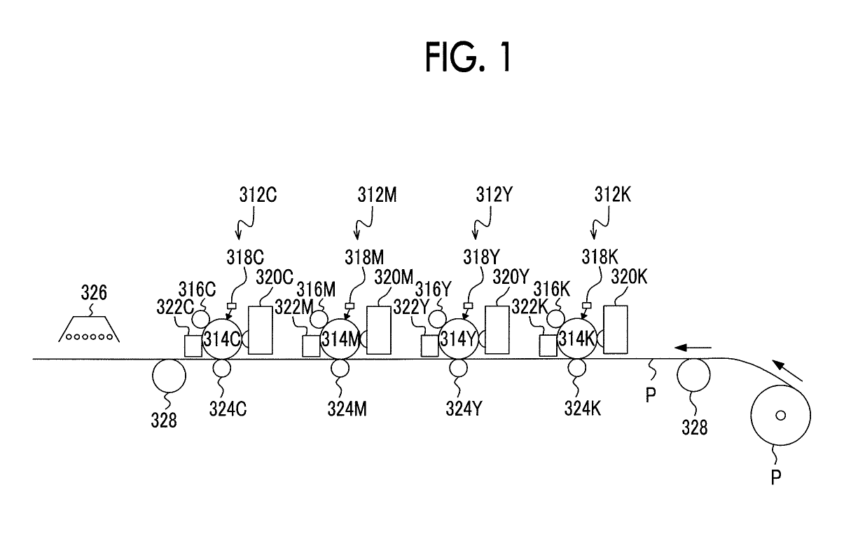

FIG. 1 is a configuration diagram showing an example of the image forming apparatus according to the exemplary embodiment. The image forming apparatus shown in FIG. 1 is an apparatus in which toner image formation is performed by toners including a black toner, in addition to three color toners of cyan, magenta, and yellow.

In the image forming apparatus shown in FIG. 1, the recording medium P wound in a roll shape is transported by a paper feeding roller 328, on one side on the recording medium P transported in this manner, four image forming units 312 (black (K), yellow (Y), magenta (M), and cyan (C)) are provided in parallel with each other toward the downstream side from the upstream side in the feeding direction of the recording medium P, and the fixing device 326 of a light fixing method is provided on the downstream side of the image forming unit 312.

An image forming unit 312K for black is an image forming unit of a known electrophotoraphic system. Specifically, a charger 316K, an exposure unit 318K, a developer unit 320K, a cleaner 322K are provided around a photoreceptor 314K, and a transfer unit 324K is provided through a recording medium P. The same is applied to each of an image forming unit 312Y for yellow, an image forming unit 312M for magenta, and an image forming unit 312C for cyan.

Moreover, in the case of being used in black and white print, only black (K) may be provided as the image forming unit 312.

In the image forming apparatus shown in FIG. 1, by each of the image forming units 312K, 312Y, 312M, and 312C, toner images are sequentially transferred on the recording medium P which is pulled out from the roll state by a known electrophotoraphic system, and the toner images are subjected to light fixing by the fixing device 326, whereby an image is formed. At the position where the fixing device 326 is provided, a heating roll pair (not shown) for fixing a toner image onto the recording medium P by pressing and heating may be provided via the recording medium P. By providing a heating device such as a heater in the roll, the heating roll pair is heated, and by contact of the toner image with the heating roll pair, the toner image is melted, and fixed on the recording medium P.

Process Cartridge

The process cartridge according to the exemplary embodiment is equipped with a developing unit that accommodates the electrostatic charge image developer and develops an electrostatic charge image formed on a surface of an image holding member with the electrostatic charge image developer to form a toner image, and is detachable from an image forming apparatus. In addition, as the electrostatic charge image developer, the electrostatic charge image developer according to the exemplary embodiment is applied.

Toner Cartridge

The toner cartridge according to the exemplary embodiment accommodates a toner and is detachable from an image forming apparatus. In addition, as the toner, the electrostatic charge image developing toner according to the exemplary embodiment is applied.

### EXAMPLES

Hereinafter, the present invention will be described in more detail based on examples, but the present invention is not limited thereto. Moreover, “parts” and “%” are based on weight unless indicated otherwise.

### Example A

### Synthesis of Specific Polyester Resin A1

Neopentyl glycol: 114 parts

Ethylene glycol: 68 parts

Terephthalic acid: 166 parts

Isophthalic acid: 166 parts

Tetrabutoxytitanate (catalyst): 2 parts

The above materials are put into a three-neck flask dried by heating, then, nitrogen gas is introduced into the flask to make an inert atmosphere, and after the temperature is raised while stirring, a co-condensation polymerization reaction is performed at 200° C. for 7 hours, then, the temperature is raised to 230° C. while slowly reducing the pressure to 1333 Pa, and the resultant product is kept for 8 hours, whereby a specific polyester resin (resin A1) is synthesized. The number average molecular weight (Mn) of the obtained specific polyester resin is 4,500, and the glass transition temperature thereof is 58° C.

Preparation of Resin Particle Dispersion A1

Resin A1: 115 parts

Ionic surfactant (manufactured by Dai-ichi Kogyo Seiyaku Co., Ltd.: NEOGEN RK): 5 parts

Ion exchange water: 180 parts

The above materials are mixed and heated to 100° C., then, the mixture is sufficiently dispersed using an Ultra Turrax T50 manufactured by IKA Japan, K.K., and a dispersion treatment is performed for 1 hour using a pressure discharge type gaulin homogenizer, whereby a resin particle dispersion A1 having a volume average particle diameter of 170 nm and an amount of solid content of 40% is prepared.

Synthesis of Specific Polyester Resin A2

1,3-propanediol: 109 parts

1,4-propanediol: 37 parts

Ethylene glycol: 13 parts

Terephthalic acid: 166 parts

Isophthalic acid: 166 parts

Tetrabutoxytitanate (catalyst): 2 parts

The above components are put into a three-neck flask dried by heating, then, nitrogen gas is introduced into the flask to make an inert atmosphere, and after the temperature is raised while stirring, a co-condensation polymerization reaction is performed at 200° C. for 7 hours, then, the temperature is raised to 230° C. while slowly reducing the pressure to 1333 Pa, and the resultant product is kept for 8 hours, whereby a specific polyester resin (resin A2) is synthesized. The number average molecular weight (Mn) of the obtained specific polyester resin is 4,300, and the glass transition temperature thereof is 60° C.

Preparation of Resin Particle Dispersion A2

Resin A2: 115 parts

Ionic surfactant (manufactured by Dai-ichi Kogyo Seiyaku Co., Ltd.: NEOGEN RK): 5 parts

Ion exchange water: 180 parts

The above materials are mixed and heated to 100° C., then, the mixture is sufficiently dispersed using an Ultra Turrax T50 manufactured by IKA Japan, K.K., and a dispersion treatment is performed for 1 hour using a pressure discharge type gaulin homogenizer, whereby a resin particle dispersion A2 having a volume average particle diameter of 180 nm and an amount of solid content of 40% is prepared.

Synthesis of Specific Polyester Resin A3

Bisphenol A bis(2-hydroxyethyl) ether: 347 parts

Ethylene glycol: 68 parts

Terephthalic acid: 166 parts

Isophthalic acid: 166 parts

Tetrabutoxytitanate (catalyst): 2 parts

The above materials are put into a three-neck flask dried by heating, then, nitrogen gas is introduced into the flask to make an inert atmosphere, and after the temperature is raised while stirring, a co-condensation polymerization reaction is performed at 210° C. for 7 hours, then, the temperature is raised to 230° C. while slowly reducing the pressure to 1333 Pa, and the resultant product is kept for 8 hours, whereby a resin A3 having an acid value of 10.0 mgKOH/g, a weight average molecular weight of 13,000, and a resin A3 having a glass transition temperature of 62° C. is obtained. The number average molecular weight (Mn) of the obtained polyester resin is 5100.

Preparation of Resin Particle Dispersion A3

The resin A3 in a molten state is transported to CAVITRON CD1010 (manufactured by EUROTEC LTD.) at a speed of 100 parts per minute. Separately, diluted ammonia aqueous solution having a concentration of 0.37% obtained by diluting reagent ammonia aqueous solution with ion exchange water is prepared, and while heating to 120° C. by a heat exchanger, is transported to the CAVITRON at the same time with the resin A3 at a speed of 0.1 liters per minute. The CAVITRON is driven with conditions where the rotation rate of the rotator is 60 Hz and the pressure is 5 kg/cm², whereby a resin particle dispersion A3 having a volume average particle diameter of 160 nm and an amount of solid content of 40% is obtained.

Synthesis of Infrared Absorbent

Synthesis of Compound (A1)

A compound (A1) (compound in which all of R^{a} to R^{d} in Formula (I) are t-butyl groups) is synthesized according to the following scheme.

A three-neck flask is provided with a Dean-Stark trap, a reflux condenser, a stirring seal, and a stirring bar, and the flask is used as a reaction vessel. 2,2,8,8-Tetramethyl-3,6-nonadiyn-5-ol and cyclohexane are put into the reaction vessel. Powder of manganese (IV) oxide is added thereto, the resultant product is stirred using a three-one motor, followed by refluxing while heating. The water generated during reaction is removed by azeotropic distillation. It is confirmed by thin layer chromatography that there is no residual of 2,2,8,8-tetramethyl-3,6-nonadiyn-5-ol. The reaction mixture is allowed to be cooled, and then, filtered under reduced pressure, whereby yellow filtrate (F1) is obtained. After the solid obtained by filtration is transferred to another vessel, an operation including addition of ethyl acetate, ultrasoni dispersion, and filtration, is repeated four times, whereby an ethyl acetate extraction liquid (F2) is obtained. The ethyl acetate extraction liquid (F2) and the filtrate (F1) are mixed, and the resultant product is concentrated using a rotary evaporator, and then, a vacuum pump, whereby orange-colored liquid is obtained. The liquid colored orange is distilled under reduced pressure, whereby pale yellow liquid (intermediate 1) is obtained.

A three-neck flask is provided with a thermometer and a dropping funnel, and the flask is used as a reaction vessel. Sodium monohydrogensulfide n-hydrate is added to ethanol, and the resultant is stirred until being dissolved at room temperature (20° C.), followed by cooling with ice water. When the inner temperature reaches 5° C., a mixture of the intermediate 1 and ethanol is added dropwise thereto little by little. By dropping, the color of the liquid is changed from yellow to orange. Since the internal temperature rises due to heat generation, dropping is performed within an internal temperature range from 5° C. to 7° C., while adjusting the dropping amount. Thereafter, the ice water bath is removed, and the resultant product is stirred at room temperature (20° C.) while naturally raising the temperature. Water is put into the reaction liquid, and the ethanol is removed using a rotary evaporator. Thereafter, sodium chloride is added until saturation, and the organic phase is collectedby liquid-liquid separation with ethyl acetate. The organic phase is washed with a saturated ammonium chloride two times, and dried over magnesium sulfate. After the drying, the resultant product is concentrated under reduced pressure, whereby brown liquid is collected. The brown liquid is distilled under reduced pressure. Although a fraction of distillation begins to come out from 200° C., the initial fraction component is not included therein, and therefore, the fraction at the time when the amount of steam increases is taken as the main fraction. Yellow liquid (intermediate 2) is distilled.

After a stirring bar and the intermediate 2 are put into a three-neck flask, the three-neck flask is provided with a nitrogen inlet tube and a reflux condenser, and nitrogen purge is performed. In a nitrogen atmosphere, anhydrous tetrahydrofuran is added thereto using a syringe, and a 1 M tetrahydrofuran (THF) solution of methylmagnesium bromide is added dropwise thereto using a syringe while stirring at room temperature (20° C.). After the reaction ends, the reaction liquid is refluxed while being heated and stirred. In a nitrogen atmosphere, the reaction liquid is allowed to be cooled, and while cooling the reaction liquid in an ice water bath, a solution obtained by dissolving ammonium bromide in water is added dropwise thereto. After the reaction mixture is further stirred at room temperature (20° C.), n-hexane is added thereto, and the resultant product is dried over sodium sulfate. After drying, a n-hexane/THF solution is taken out using a syringe, the inorganic layer is washed with ethyl acetate, whereby extraction liquid is obtained. The n-hexane/THF solution and the extraction liquid from the inorganic layer are mixed, and the resultant product is concentrated under reduced pressure and vacuum-dried, whereby an intermediate 3 is obtained.

In a nitrogen atmosphere, the intermediate 3 and squaric acid are dispersed in a mixed solvent of cyclohexane and isobutanol, and pyridine is added thereto, followed by refluxing while heating. Thereafter, isobutanol is additionally added thereto, and the reaction mixture is further heated to reflux. The water generated during reaction is removed by azeotropic distillation. The reaction mixture is allowed to be cooled, and then, filtered under reduced pressure, whereby insoluble materials are removed. The filtrate is concentrated using a rotary evaporator. Methanol is added to the residue, and the resultant product is heated to 40° C., and then, cooled to −10° C. Crystals are obtained by filtration, and this is vacuum-dried, whereby a compound (A1) is obtained.

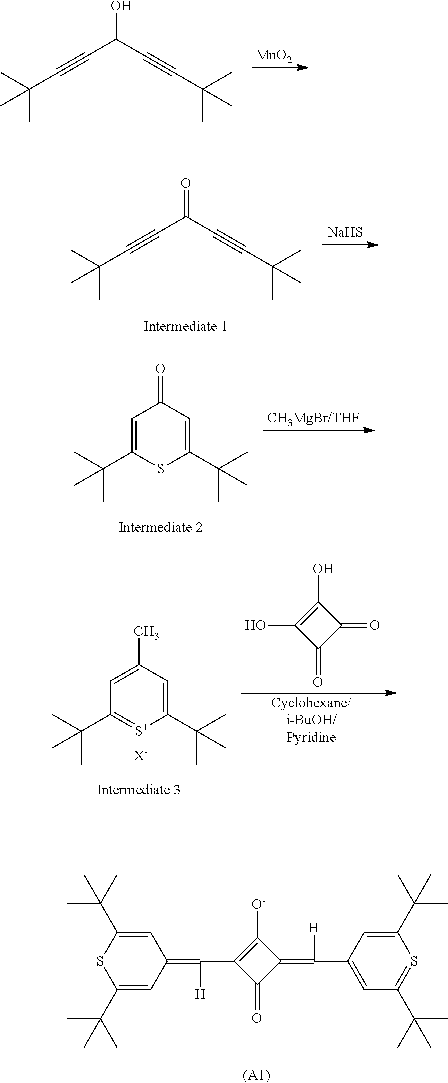

Preparation of Infrared Absorbent Dispersion A1

Specific infrared absorbent (A1): 10 parts Anionic surfactant (NEOGEN R, manufactured by Dai-ichi Kogyo Seiyaku Co., Ltd.): 1 part

Ion exchange water: 89 parts

The above materials are mixed, and a dispersion treatment is performed thereon for 30 minutes at 150 W using an ultrasonic homogenizer (US-150T, manufactured by NISSEI Corporation), whereby an infrared absorbent dispersion A1 having a volume average particle diameter of 250 nm and an amount of solid content of 11% is obtained.

Synthesis of Specific Infrared Absorbent (A2)

A specific infrared absorbent (A2): (compound in which all of R^{a} to R^{d} in Formula (I) are i-propyl groups) is synthesized in the same manner as in the synthesis of the specific infrared absorbent (A1) except that 2,8-dimethyl-3,6-nonadiyn-5-ol is used instead of 2,2,8,8-tetramethyl-3,6-nonadiyn-5-ol.

(Identification Data)

¹H-NMR spectrum (CDCl₃): 9.1 (2H), 6.8 (2H), 6.1 (2H), 2.8˜3.0 (4H), 1.2˜1.3 (24H)

Mass spectrum (FD): m/z=467

Molar absorption coefficient (ε) spectrum: maximum absorption wavelength (λₘₐₓ)=809 nm (THF), molar absorption coefficient (εₘₐₓ) at the maximum absorption wavelength=3.6×10⁵ M⁻¹cm⁻¹

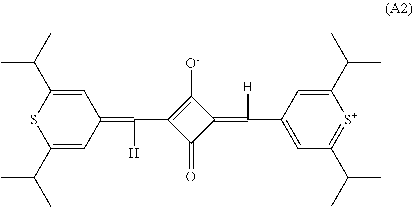 [SMILES: CC(C)C1=CC(=CC2=C([O-])/C(=C/c3cc(C(C)C)[s+]c(C(C)C)c3)C2=O)C=C(C(C)C)S1]

Preparation of Infrared Absorbent Dispersion A2

Specific infrared absorbent (A2): 10 parts Anionic surfactant (NEOGEN R, manufactured by Dai-ichi Kogyo Seiyaku Co., Ltd.): 1 part

Ion exchange water: 89 parts

The above materials are mixed, and a dispersion treatment is performed thereon for 30 minutes at 150 W using an ultrasonic homogenizer (US-150T, manufactured by NISSEI Corporation), whereby an infrared absorbent dispersion A2 having a volume average particle diameter of 250 nm and an amount of solid content of 11% is obtained.

Synthesis of Specific Infrared Absorbent (A3)

A specific infrared absorbent (A3): (compound in which all of R^{a} to R^{d} in Formula (I) are i-butyl groups) is synthesized in the same manner as in the synthesis of the specific infrared absorbent (A1) except that 2,10-dimethyl-4,7-undecan-6-ol is used instead of 2,2,8,8-tetramethyl-3,6-nonadiyn-5-ol.

(Identification Data)

¹H-NMR spectrum (CDCl₃):

9.1 (2H), 6.8 (2H), 6.1 (2H), 2.4˜2.6 (8H), 1.8˜2.0 (4H), 0.8˜1.0 (24H)

Mass spectrum (FD): m/z=523

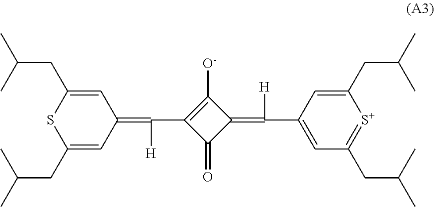 [SMILES: CC(C)CC1=CC(=CC2=C([O-])/C(=C/c3cc(CC(C)C)[s+]c(CC(C)C)c3)C2=O)C=C(CC(C)C)S1]

Preparation of Infrared Absorbent Dispersion A3

Specific infrared absorbent (A3): 10 parts

Anionic surfactant (NEOGEN R, manufactured by Dai-ichi Kogyo Seiyaku Co., Ltd.): 1 part

Ion exchange water: 89 parts

The above materials are mixed, and a dispersion treatment is performed thereon for 30 minutes at 150 W using an ultrasonic homogenizer (US-150T, manufactured by NISSEI Corporation), whereby an infrared absorbent dispersion A3 having a volume average particle diameter of 250 nm and an amount of solid content of 11% is obtained.

Synthesis of Infrared Absorbent (A4)

A specific infrared absorbent (A4): (compound in which all of R^{a} to R^{d} in Formula (I) are n-butyl groups) is synthesized in the same manner as in the synthesis of the specific infrared absorbent (A1) except that trideca-5,8-diyn-7-ol is used instead of 2,2,8,8-tetramethyl-3,6-nonadiyn-5-ol.

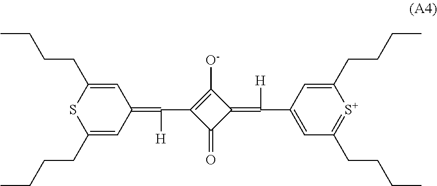 [SMILES: CCCCC1=CC(=CC2=C([O-])/C(=C/c3cc(CCCC)[s+]c(CCCC)c3)C2=O)C=C(CCCC)S1]

Preparation of Infrared Absorbent Dispersion A4

Specific infrared absorbent (A4): 10 parts

Anionic surfactant (NEOGEN R, manufactured by Dai-ichi Kogyo Seiyaku Co., Ltd.): 1 part

Ion exchange water: 89 parts

The above materials are mixed, and a dispersion treatment is performed thereon for 30 minutes at 150 W using an ultrasonic homogenizer (US-150T, manufactured by NISSEI Corporation), whereby an infrared absorbent dispersion A4 having a volume average particle diameter of 250 nm and an amount of solid content of 11% is obtained.

Synthesis of Infrared Absorbent (A5)

A specific infrared absorbent (A5): (compound in which all of R^{a} to R^{d} in Formula (I) are n-propyl groups) is synthesized in the same manner as in the synthesis of the specific infrared absorbent (A1) except that undeca-4,7-diyn-6-ol is used instead of 2,2,8,8-tetramethyl-3,6-nonadiyn-5-ol.

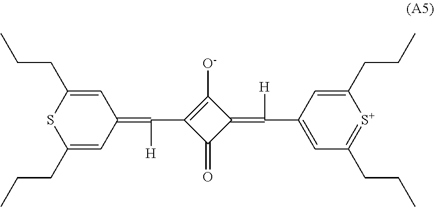 [SMILES: CCCC1=CC(=CC2=C([O-])/C(=C/c3cc(CCC)[s+]c(CCC)c3)C2=O)C=C(CCC)S1]

Preparation of Infrared Absorbent Dispersion A5

Infrared absorbent (A5): 10 parts

Anionic surfactant (NEOGEN R, manufactured by Dai-ichi Kogyo Seiyaku Co., Ltd.): 1 part

Ion exchange water: 89 parts

The above materials are mixed, and a dispersion treatment is performed thereon for 30 minutes at 150 W using an ultrasonic homogenizer (US-150T, manufactured by NISSEI Corporation), whereby an infrared absorbent dispersion A5 having a volume average particle diameter of 250 nm and an amount of solid content of 11% is obtained.

Synthesis of Infrared Absorbent (A6)

In the following manner, an infrared absorbent (A6) is synthesized. A mixture of 4.8 g (98%, 30 mmol) of 1,8-diaminonaphthalene, 3.9 g (98%, 30 mmol) of 2,6-dimethyl-4-heptanone, 40 mg (0.2 mmol) of p-toluenesulfonic acid monohydrate, and 45 ml of toluene is heated while being stirred in a nitrogen gas atmosphere, followed by refluxing at 110° C. for 7 hours. The water generated during reaction is removed by azeotropic distillation. After the reaction ends, a dark brown solid obtained by distilling off the toluene is extracted with acetone, and the resultant product is purified by recrystallization from a mixed solvent of acetone and ethanol, and dried, whereby 7.625 g of an intermediate (a) is obtained (yield of 90%).

A mixed liquid of 1.4 g (12 mmol) of 3,4-dihydroxy-3-cyclobutene-1,2-dione, 40 ml of n-butanol, and 60 ml of toluene is added to 7.625 g of the intermediate (a), and the resultant product is heated while being stirred in a nitrogen gas atmosphere, and subjected to a reaction under reflux at 105° C. for 3 hours. The water generated during reaction is removed by azeotropic distillation. After the reaction ends, the solvent is distilled off in a nitrogen gas atmosphere, and 120 ml of n-hexane is added thereto while stirring the obtained reaction mixture. Suction filtration is performed on the produced black brown precipitate, and the resultant product is washed with n-hexane, and dried, whereby a black brown solid is obtained. This solid is washed with ethanol, whereby 6.2 g (yield of 80%) of an infrared absorbent (A6) is obtained.

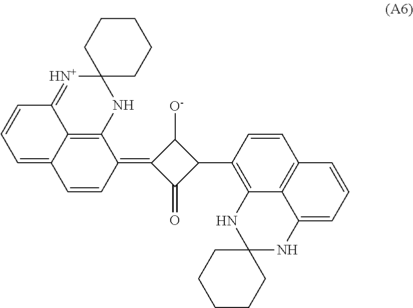 [SMILES: O=C1/C(=c2\ccc3cccc4c3c2NC2(CCCCC2)[NH+]=4)C([O-])C1c1ccc2cccc3c2c1NC1(CCCCC1)N3]

Preparation of Infrared Absorbent Dispersion A6

0.25 g of the infrared absorbent (A6), 2.5 mL of tetrahydrofuran (THF), and 15 g of zirconia beads having a diameter of 1 mm are put into a vessel for ball mill, and a milling treatment is performed thereon for 1 hour. Water is added to the vessel for ball mill, and the resultant product is filtered using a filter, whereby the micronized infrared absorbent (A6) is collected. The volume average particle diameter is 150 nm.

0.20 g of the micronized infrared absorbent (A6), 1 ml of 12% sodium dodecylbenzenesulfonate aqueous solution, and 100 ml of distilled water are mixed, and the resultant product is ultrasonically dispersed, whereby slurry is prepared (ultrasonic output: 4 W to 5 W, ¼ inch horn is used, irradiation time of 30 minutes). The sample concentration in the slurry is 0.20% by weight.

### Preparation of Resin Composition

### Example A1-1

263 parts of the obtained resin particle dispersion A1, 1.91 parts of the obtained infrared absorbent dispersion A1, 0.3 parts of polyaluminum chloride are put into a round flask made of stainless steel, and the resultant product is mixed and dispersed using a homogenizer (Ultra Turrax T50 manufactured by IKA Japan, K.K.). Next, 0.15 parts of polyaluminum chloride is added thereto, and the dispersion operation is continued using the homogenizer. The temperature is heated to 47° C. while stirring the flask in an oil bath for heating, and the temperature is kept for 60 minutes. Thereafter, the pH in the system is adjusted to 5.4 with a 0.5 mol/L sodium hydroxide aqueous solution, and then, the stainless flask is sealed, heated to 96° C. while stirring using a magnetic seal, and kept for 2 hours.

After the reaction ends, the resultant product is cooled to room temperature, the solid is separated by filtration, and sufficiently washed with ion exchange water, and solid-liquid separation is performed by Nutsche type suction filtration. This is further redispersed in 3 L of ion exchange water at 40° C., and the resultant product is washed by stirring for 15 minutes at 300 rpm. This is further repeated five times, and when the pH of the filtrate becomes 7.0, the filtrate is filtered, and the resultant product is subjected to vacuum drying for 12 hours, whereby particles of a resin composition having a volume average particle diameter of 5.7 μm are obtained.

### Example A1-2 and Reference Example A1-3

Particles of the resin composition are obtained in the same manner as in Example A1-1 except that the resin particle dispersion A2 and the resin particle dispersion A3 are used respectively instead of the resin particle dispersion A1.

### Comparative Example A2-1, Comparative Example A2-2, and Reference Example A2-3

Particles of the respective resin compositions are obtained in the same manner as in Example A1-1, Example A1-2, and Reference Example A1-3 except that the infrared absorbent dispersion A2 is used instead of the infrared absorbent dispersion A1.

### Comparative Example A3-1, Comparative Example A3-2, and Reference Example A3-3

Particles of the respective resin compositions are obtained in the same manner as in Example A1-1, Example A1-2, and Reference Example A1-3 except that the infrared absorbent dispersion A3 is used instead of the infrared absorbent dispersion A1.

### Comparative Example A4-1, Comparative Example A4-2, and Reference Example A4-3

Particles of the respective resin compositions are obtained in the same manner as in Example A1-1, Example A1-2, and Reference Example A1-3 except that the infrared absorbent dispersion A4 is used instead of the infrared absorbent dispersion A1.

### Comparative Example A5-1, Comparative Example A5-2, and Reference Example A5-3

Particles of the respective resin compositions are obtained in the same manner as in Example A1-1, Example A1-2, and Reference Example A1-3 except that the infrared absorbent dispersion A5 is used instead of the infrared absorbent dispersion A1.

### Comparative Example A6-1, Comparative Example A6-2, and Reference Example A6-3

Particles of the respective resin compositions are obtained in the same manner as in Example A1-1, Example A1-2, and Reference Example A1-3 except that 105 parts of the infrared absorbent dispersion A6 is used instead of 1.91 parts of the infrared absorbent dispersion A1.

Calculation of Molar Absorption Coefficient of Infrared Absorbent Solution

The IR transmission spectrum of a specific infrared absorbent solution obtained by dissolving each of the specific infrared absorbents A1 to A3 and the specific infrared absorbents A4 to A6 in tetrahydrofuran is measured using a spectrophotometer U-4100 manufactured by Hitachi, Ltd., and the molar absorption coefficient (molar absorption coefficient of the infrared absorbent solution) at the absorption peak is calculated. The results are shown in Table 1.

Calculation of Molar Absorption Coefficient of Rein Particle Solution

IR transmission spectrum of a resin composition solution obtained by dissolving each of the obtained particles of the resin compositions in tetrahydrofuran is measured using a spectrophotometer U-4100 manufactured by Hitachi, Ltd., and the molar absorption coefficient (molar absorption coefficient of the resin composition solution) at the absorption peak is calculated.

In addition, the “single ratio (%)”, that is, the ratio of the molar absorption coefficient of the resin composition solution when the molar absorption coefficient of the infrared absorbent solution is set to 100 is determined. The results are shown in Table 1.

The “single ratio (%)” is a value indicating how much infrared absorption performance of an infrared absorbent in a resin composition solution is exhibited compared to a solution of only the infrared absorbent. In a case where the single ratio is close to 100%, it is thought that the infrared absorption amount in a resin composition solution is equal to the value of the infrared absorption amount in an infrared absorbent solution, the infrared absorbent is sufficiently incorporated into the resin, and the function of the infrared absorbent is exhibited even in the presence of the resin. In contrast, in a case where the single ratio is low, it is thought that infrared absorption performance is impaired by mixing an infrared absorbent into the resin, for example, for a reason such as that the infrared absorbent is not incorporated into the resin, or aggregated or decomposed.

TABLE 1

| | Infrared | | | | | | | | | |
|---|---|---|---|---|---|---|---|---|---|---|
| | absorbent | Resin composition solution | | | | | | | | |
| | solution | Resin particle dispersion A1 | | | Resin particle dispersion A2 | | | Resin particle dispersion A3 | | |
| Infrared | Molar | | Molar | | | Molar | | | Molar | |
| absorbent | absorption | | absorption | Single | | absorption | Single | | absorption | Single |
| dispersion | coefficient | | coefficient | ratio | | coefficient | ratio | | coefficient | ratio |
| A1 | 345,000 | Example A1-1 | 345,000 | 100% | Example A1-2 | 342,000 | 99% | Reference | 345,000 | 100% |
| | | | | | | | | Example A1-3 | | |
| A2 | 357,000 | Example A2-1 | 324,000 | 91% | Example A2-2 | 319,000 | 89% | Reference | 348,000 | 97% |
| | | | | | | | | Example A2-3 | | |
| A3 | 334,000 | Example A3-1 | 318,000 | 95% | Example A3-2 | 314,000 | 94% | Reference | 332,000 | 99% |
| | | | | | | | | Example A3-3 | | |
| A4 | 351,000 | Comparative | 313,000 | 89% | Comparative | 306,000 | 87% | Reference | 337,000 | 96% |
| | | Example A4-1 | | | Example A4-2 | | | Example A4-3 | | |
| A5 | 359,000 | Comparative | 312,000 | 87% | Comparative | 305,000 | 85% | Reference | 336,000 | 94% |
| | | Example A5-1 | | | Example A5-2 | | | Example A5-3 | | |
| A6 | 157,000 | Comparative | 12,0000 | 76% | Comparative | 116,000 | 74% | Reference | 153,000 | 97% |
| | | Example A6-1 | | | Example A6-2 | | | Example A6-3 | | |

From the above results, it is found that, in the resin composition solutions of Examples A1-1, A1-2, A2-1, A2-2, A3-1, and A3-2, the molar absorption coefficient at the absorption peak and the single ratio are great, compared to the resin composition solutions of Comparative Examples A4-1, A4-2, A5-1, A5-2, A6-1, and A6-2. Thus, it is thought that, in the resin compositions of the above examples using the specific polyester resin and the specific infrared absorbent, deterioration of infrared absorption performance is prevented compared to the resin compositions of the above comparative examples using the specific polyester resin and the infrared absorbent (A4).

### Example B

### Synthesis of Specific Acrylic Resin B1 and Preparation of Resin Particle Dispersion B1

Styrene: 238 parts

n-Butyl acrylate: 80 parts

Hydroxyethyl methacrylate: 81 parts

Acrylic acid: 4 parts

Non-ionic surfactant (manufactured by Dai-ichi Kogyo Seiyaku Co., Ltd.: NEOGEN EA-157): 5 parts

Anionic surfactant (NEOGEN SC, manufactured by Dai-ichi Kogyo Seiyaku Co., Ltd.): 7 parts

Ion exchange water: 550 parts

The above materials are put into a flask, dispersed, and emulsified, then, while slowly stirring and mixing for 10 minutes, 50 parts of ion exchanged water in which 4 parts of potassium persulfate is dissolved is put thereinto, and nitrogen purge is performed. While stirring the inside of the flask, heating is performed until the temperature of the content reaches 50° C., and a monomer mixture is added over 90 minutes. After the addition ends, emulsion polymerization is continued for 5 hours. Thus, a resin particle dispersion B1 obtained by dispersing resin particles of a specific acrylic resin B1 having an average particle diameter of 160 nm, a weight average molecular weight of 90,000, and a glass transition temperature of 56° C. is prepared.

Synthesis of Acrylic Resin B2 and Preparation of Resin Particle Dispersion B2

Styrene: 320 parts

n-Butyl acrylate: 80 parts

Acrylic acid: 10 parts

Dodecanethiol: 10 parts

Non-ionic surfactant (NONIPOL 400, manufactured by Sanyo Chemical Industries, Ltd.): 6 parts

Anionic surfactant (NEOGEN R, manufactured by Dai-ichi Kogyo Seiyaku Co., Ltd.): 10 parts

Ion exchange water: 550 parts

The above materials are put into a flask, dispersed, and emulsified, and while slowly stirring and mixing for 10 minutes, 50 parts of ion exchanged water in which 4 parts of ammonium persulphate is dissolved is put thereinto. Thereafter, the inside of the flask is replaced with nitrogen and heated using an oil bath until the inside of the system reaches 70° C. while stirring, and emulsion polymerization is continued for 5 hours, whereby a resin particle dispersion B2 in which resin particles of an acrylic resin B2 are dispersed, having an amount of solid content of 43% is obtained.

The volume average particle diameter of the resin particles is 155 nm, the glass transition temperature of the acrylic resin B2 is 54° C., and the weight average molecular weight is 33,000.

### Preparation of Resin Composition

### Example B1-1

280 parts of the obtained resin particle dispersion B1, 2.19 parts of the infrared absorbent dispersion A1, 1.5 parts of a cationic surfactant (SANISOL B50, manufactured by Kao Corporation), 0.36 parts of polyaluminum chloride, and 1,000 parts of ion exchange water are put into a round flask made of stainless steel, followed by mixing and dispersing using a homogenizer (Ultra Turrax T50, manufactured by IKA Japan, K.K.), and the resultant product is heated to 48° C. while being stirred. After the resultant product is kept at 48° C. for 30 minutes, the formation of aggregated particles is confirmed using an optical microscope. Thereafter, the pH of the liquid in a sodium hydroxide aqueous solution having a concentration of 0.5 mol/L is adjusted to 8.0, and the resultant product is heated to 90° C., followed by further stirring for 3 hours.

After the reaction ends, the resultant product is cooled, and solid-liquid separation is performed thereon by Nutsche type suction filtration. The solid content is redispersed in 1,000 parts of ion exchange water at 30° C., followed by stirring for 15 minutes at 300 rpm using a stirring blade, and solid-liquid separation is performed by Nutsche type suction filtration. The redispersion and suction filtration are repeated, and when the electric conductivity of the filtrate becomes 10.0 μS/cmt or less, washing is stopped. Next, the resultant product is continuously dried for 12 hours in a vacuum dryer, whereby particles of a resin composition having a volume average particle diameter of 5.8 μm is obtained.

### Reference Example B1-2

Particles of the resin composition are obtained in the same manner as in Example B1-1 except that the resin particle dispersion B2 is used instead of the resin particle dispersion B1.

### Comparative Example B2-1 and Reference Example B2-2

Particles of the respective resin compositions are obtained in the same manner as in Example B1-1 and Reference Example B1-2 except that the infrared absorbent dispersion A4 is used instead of the infrared absorbent dispersion A1.

Calculation of Molar Absorption Coefficient of Rein Particle Solution

IR transmission spectrum of a resin composition solution obtained by dissolving each of the obtained resin compositions in tetrahydrofuran is measured using a spectrophotometer U-4100 manufactured by Hitachi, Ltd., and the molar absorption coefficient (molar absorption coefficient of the resin composition solution) at the absorption peak is calculated. The results are shown in Table 2.

TABLE 2

| | Infrared | | | | | | |
|---|---|---|---|---|---|---|---|
| | absorbent | Resin composition solution | | | | | |
| | solution | Resin particle dispersion B1 | | | Resin particle dispersion B2 | | |
| Infrared | Molar | | Molar | | | Molar | |
| absorbent | absorption | | absorption | Single | | absorption | Single |
| dispersion | coefficient | | coefficient | ratio | | coefficient | ratio |
| A1 | 345,000 | Example B1-1 | 338100 | 98% | Reference | 341550 | 99% |
| | | | | | Example B1-2 | | |
| A4 | 351,000 | Comparatibe | 308880 | 88% | Reference | 336960 | 96% |
| | | Example B2-1 | | | Example B2-2 | | |

From the above results, it is found that, in the resin composition solution of Example B1-1, the molar absorption coefficient at the absorption peak and the single ratio are great, compared to the resin composition solution of Comparative Example B2-1. Thus, it is thought that, in the resin composition of the above example using the specific acrylic resin and the specific infrared absorbent, deterioration of infrared absorption amount is prevented compared to the resin composition of the above comparative example using the specific acrylic resin and the infrared absorbent (A4).

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A resin composition, comprising:
a polyester resin which contains a structural unit derived from bisphenol A in an amount of 1% by weight or less with respect to the total amount of polyester resin; and
a compound represented by the following Formula (I): 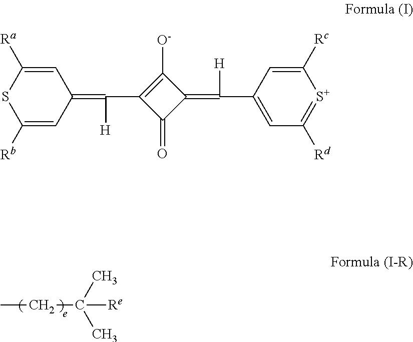
wherein, in Formula (I), R^{a} represents a group represented by Formula (I-R), and each of R^{b}, R^{c}, and R^{d} independently represents an alkyl group; and
in Formula (I-R), R^{e} represents hydrogen or a methyl group, and e represent an integer from 0 to 3.

2. A resin composition, comprising:
an acrylic resin having an OH group on a branch thereof; and
a compound represented by the following Formula (I), 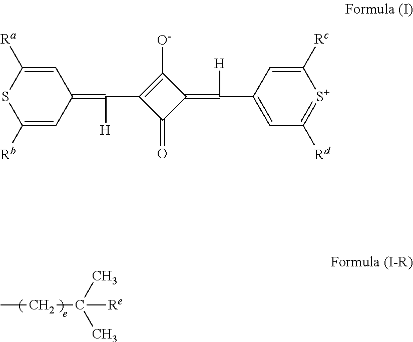
wherein, in Formula (I), R^{a} represents a group represented by Formula (I-R), and each of R^{b}, R^{c}, and R^{d} independently represents an alkyl group; and
in Formula (I-R), R^{e} represents hydrogen or a methyl group, and e represent an integer from 0 to 3.

3. The resin composition according to claim 1,
wherein at least one of R^{b}, R^{c}, and R^{d} in Formula (I) is a group represented by Formula (I-R).

4. The resin composition according to claim 2,
wherein at least one of R^{b}, R^{c}, and R^{d} in Formula (I) is a group represented by Formula (I-R).

5. The resin composition according to claim 1,
wherein all of R^{b}, R^{c}, and R^{d} in Formula (I) are the groups represented by Formula (I-R).

6. The resin composition according to claim 2,
wherein all of R^{b}, R^{c}, and R^{d} in Formula (I) are the groups represented by Formula (I-R).

7. The resin composition according to claim 1,
wherein R^{e} in Formula (I-R) is a methyl group.

8. The resin composition according to claim 2,
wherein R^{e} in Formula (I-R) is a methyl group.

9. The resin composition according to claim 3,
wherein R^{e} in Formula (I-R) is a methyl group.

10. The resin composition according to claim 4,
wherein R^{e} in Formula (I-R) is a methyl group.

11. The resin composition according to claim 5,
wherein R^{e} in Formula (I-R) is a methyl group.

12. The resin composition according to claim 6,
wherein R^{e} in Formula (I-R) is a methyl group.

13. The resin composition according to claim 1,
wherein e in Formula (I-R) is 0.

14. The resin composition according to claim 2,
wherein e in Formula (I-R) is 0.

15. An electrostatic charge image developing toner, comprising:
the resin composition according to claim 1.

16. A toner cartridge that is detachable from an image forming apparatus, comprising the electrostatic charge image developing toner according to claim 15.
